(19) United States
(12) Patent Application Publication
(10) Pub. No.: US 2008/0082557 A1
(43) Pub. Date: Apr. 3, 2008

(54) BUSINESS CARD INFORMATION MANAGEMENT SYSTEM

(75) Inventors: Kiyotaka Ohara, Nagoya (JP); Sakiko Kobayashi, Nagoya (JP); Syuichiro Shimoki, Nagoya (JP); Takao Seki, Nagoya (JP); Masafumi Miyazawa, Nagoya (JP); Tomoko Saito, Nagoya (JP); Masanori Oda, Nagoya (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya (JP)

(21) Appl. No.: 11/863,941

(22) Filed: Sep. 28, 2007

(30) Foreign Application Priority Data
Sep. 29, 2006 (JP) 2006-269828
Sep. 29, 2006 (JP) 2006-269824
Sep. 29, 2006 (JP) 2006-269829
Sep. 29, 2006 (JP) 2006-269832
Sep. 29, 2006 (JP) 2006-269838

(51) Int. Cl. G06F 17/30

(52) U.S. Cl. 707/100; 707/E17.001

(57) ABSTRACT

There is provided a business card information management system including a server and portable devices. The server includes a storage unit storing a personal table having a record containing a user ID and business card information, an acquaintance table which is associated with a record of the personal table of a certain user and has a record containing a user ID of another user, and a meeting table having a record containing meeting data. The server includes an addition unit to add a new record to the meeting table to store the meeting data. The portable device includes a data exchange unit to exchange user IDs, a date and time obtaining unit to obtain a date and time as the meeting data, and a transmission unit to transmit the meeting data, a portable device's own user ID and another user's ID to the server.

### CROSS-REFERENCE TO RELATED APPLICATION

This application claims priority under 35 U.S.C. § 119 from Japanese Patent Applications Nos. 2006-269828, filed on Sep. 29, 2006, 2006-269824, filed on Sep. 29, 2006, 2006-269829, filed on Sep. 29, 2006, 2006-269832, filed on Sep. 29, 2006, and 2006-269838, filed on Sep. 29, 2006. The entire subject matter of the applications is incorporated herein by reference.

### BACKGROUND

1. Technical Field

Aspects of the present invention relate to a business card information management system enabling portable devices to exchange business card information by data communication.

2. Related Art

Electronic business card devices capable of recording a date and time when business card information is exchanged as well as recording the business card information have been proposed. An example of such an electronic business card device is disclosed in Japanese Patent Provisional Publication No. HEI 7-64923.

### SUMMARY

The electronic business card device is used to record information concerning a number of meetings with different persons. There is a demand that business card information and the dates and times regarding a number of meetings should be effectively stored in the electronic business card device.

Aspects of the present invention are advantageous in that a business card information management system capable of effectively recording business card information of users, and dates and times of meetings with respective users is provided.

According to an aspect of the invention, there is provided a business card information management system, comprising a server; and a plurality of portable devices communicatably connected to the server. In the system, the server comprises a storage unit storing: a personal table in which a record containing a user ID and business card information of a user corresponding the user ID is stored for each of a plurality of users of the plurality of portable devices; an acquaintance table which is associated with one of records of the personal table corresponding to a certain user of the plurality of users, the acquaintance table having at least one record containing a user ID of one of the plurality of users other than the certain user; and a meeting table which is associated with one of the at least one record of the acquaintance table corresponding to one of the plurality of users other than the certain user, the meeting table having at least one record containing meeting data representing a date and time of a meeting. The server further comprises an addition unit configured such that in response to receipt of the meeting data representing a date and time of a meeting from one of the plurality of portable devices, the addition unit adds a new record to the meeting table and to store the meeting data in the new record.

In the system, each of the plurality portable devices comprises: a data exchange unit configured to exchange user IDs with another one of the plurality of the portable devices; a date and time obtaining unit configured to obtain a date and time as the meeting data in response to exchange of user IDs by the data exchange unit; and a transmission unit configured to transmit the meeting data, a portable device's own user ID and another user's ID obtained from another one of the plurality of the portable devices by the data exchange unit, to the server, in response to exchange of user IDs by the data exchange unit.

With this configuration it is possible to store records representing meetings of the certain user and another user in the meeting table which is associated with the record of the personal table corresponding to the certain user. Therefore, it is possible to effectively store the date and time data regarding the meetings and the business card information of another user with which the certain user met.

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

### BRIEF DESCRIPTION OF THE ACCOMPANYING DRAWINGS

FIG. 1 illustrates a system configuration of a business card information management system 1 according to a first embodiment.

FIG. 2 shows a data structure of various information tables stored in a server provided in the business card information management system.

FIG. 3 is a block diagram of a control system of a portable device provided in the business card information management system.

FIG. 4A illustrates a typical state where time information is displayed on the portable device.

FIG. 4B illustrates a browsing mode where star images and brief information of a user are displayed on the portable device.

FIG. 4C illustrates detailed information displayed on the portable device in a detailed data browsing mode.

FIG. 5 is a flowchart illustrating a main process executed under control of the portable device.

FIG. 6 is a flowchart illustrating a process of a business card registration mode executed under control of the portable device.

FIG. 7 is a flowchart illustrating a process of a handshake mode executed under control of the portable device in the main process.

FIG. 8 is a flowchart illustrating a process of a data browsing mode executed under control of the portable device in the main process.

FIG. 9 is a flowchart illustrating a process of a browsing mode executed under control of the portable device.

FIG. 10 is a flowchart illustrating a process of a detailed data browsing mode executed under control of the portable device.

FIG. 11 is a flowchart illustrating a process of a lock mode executed under control of the portable device.

FIG. 12 is a flowchart illustrating a process of a calibration mode executed under control of the portable device.

FIG. 13 is a flowchart illustrating a process of a security lock registration mode executed under control of the portable device.

FIG. 14 is a flowchart illustrating a process of a temporary table update mode executed under control of the portable device.

FIG. 15 illustrates an example of a screen in which information including personal information and meeting data is displayed.

FIG. 16 is an explanatory illustration for explaining a relationship between a position of the portable device calculated based on accelerations detected by an acceleration sensor and a distance corresponding to a difficulty level.

FIG. 17 is a flowchart illustrating a main process according to a second embodiment.

FIG. 18 is a flowchart illustrating a process of a difficulty setting mode for security lock according to the second embodiment.

FIG. 19 is a flowchart illustrating a process of motion authentication according to the second embodiment.

FIG. 20 illustrates a table data structure of tables stored in the server according to a third embodiment.

FIG. 21 is a flowchart illustrating a process of a handshake mode according to the third embodiment.

FIG. 22 is a flowchart illustrating a process of a temporary table update mode according to the third embodiment.

### DETAILED DESCRIPTION

Hereafter, embodiments according to the invention will be described with reference to the accompanying drawings.

### FIRST EMBODIMENT

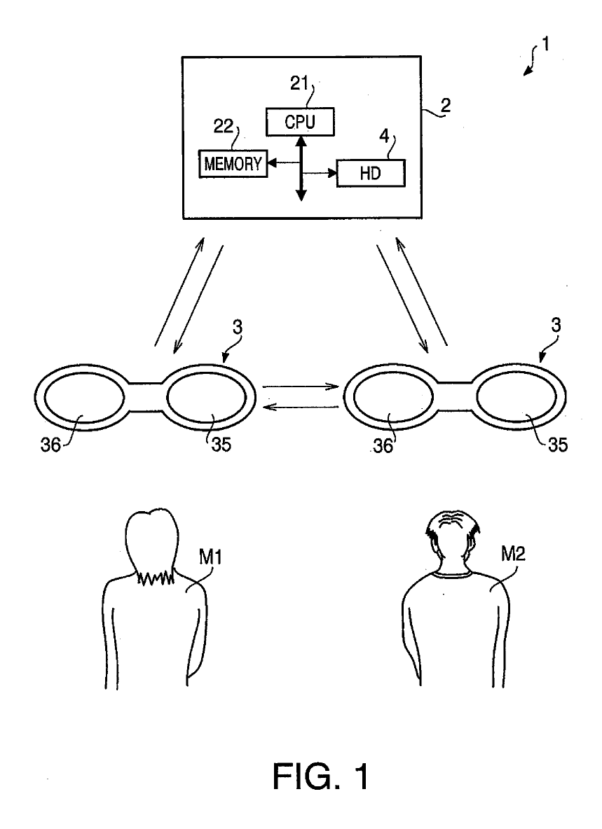

FIG. 1 illustrates a system configuration of a business card information management system 1 according to a first embodiment of the invention. The business card information management system 1 includes a server 2 and more than one electronic business card exchange device 3 (hereafter, simply referred to as a portable device 3). Hereafter, a user of one portable device 3 is referred to as a principal M1, while a user of the other potable device 3 is referred to as another person M2.

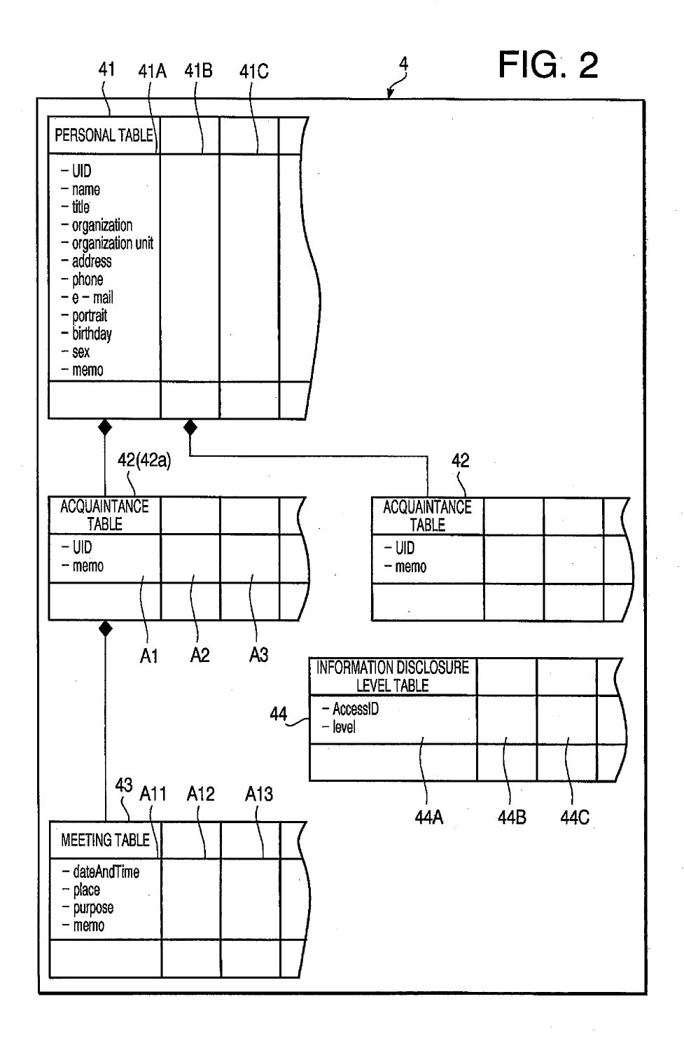

As shown in FIG. 1, the server 2 includes a CPU 21, a memory 22 storing various programs, a hard disk 4 storing various types of data. The server 2 has a communication interface, a keyboard, a mouse and a display although these components are not illustrated in FIG. 1 for the sake of simplicity. FIG. 2 shows a data structure of various information tables stored in the hard disk 4 of the server 2. As shown in FIG. 2, the hard disk 4 stores a personal table 41, an acquaintance table 42, a meeting table 43, and information disclosure level table 44.

The personal table 41 includes personal information records 41A, 41B, 41C, . . . , for each of users. Each personal information record includes a user ID, business card information, and a memo regarding a corresponding user. The business card information includes, for example, a name, a job title, a company name to which a user belongs, a division to which the user belongs, an address of the company, a phone number, an e-mail address, a portrait (photograph), a date of birth, and gender which are indicated by “-UID”, “-name”, “-title”, “-organization”, “-organization unit”, “-address”, “-phone”, “-e-mail”, “-portrait”, “-birthday”, and “-sex” in FIG. 2. Incidentally, the business card information may include all of the above-described items or only part of the above items. Further, the business card information may include additional items which may be added to the above-described items and/or replaces part of the above-described items. In the following, it is assumed that the personal information record 41A stores information on the principal M1, and the personal information record 41B stores information on another person M2.

The acquaintance table 42 is prepared for each user. That is, each acquaintance table 42 is associated with a personal information record (41A, 41B or 41C) of a corresponding user. Each acquaintance table 42 includes acquaintance records A1, A2, A3, . . . for each of acquaintances. For example, the left side acquaintance table 42a store information regarding acquaintances of the user corresponding to the personal information record 41A. It should be understood that the number of acquaintance records increases as the number of acquaintances of the corresponding user increases. Each acquaintance record (A1, A2, A3, . . . ) includes a user Id and memo regarding one acquaintances. In the following, it is assumed that the acquaintance record A1 stores information on another person M2.

The meeting table 43 is associated with one of the acquaintance records (A1, A2, A3, . . . ). Since in FIG. 2 the meeting table 43 is associated with the acquaintance record A1, the meeting table 43 stores information on meetings with the acquaintance corresponding to the acquaintance record A1. The meeting table 43 stores a meeting record (All, A12, A13, . . . ) for each of meetings. A new meeting record is added to the meeting table 43 each time a meeting of the user corresponding to the personal information record 41A (i.e., the principal M1) and the acquaintance corresponding to the acquaintance record A1 is newly held. Each of the meeting records (A11, A12, A13, . . . ) stores a date and time, a place, a purpose, and a memo regarding a corresponding meeting.

The server 2 may be configured to allow a user to directly input information of each personal information record (41A, 41B, 41C, . . . ), the memo in the acquaintance record 42, and the memo of the meeting table 43 through a user interface. Alternatively or additionally, a user of the potable device 3 may input the information of each personal information record (41A, 41B, 41C, . . . ), the memo in the acquaintance record 42, and the memo of the meeting table 43, by using a terminal device which is communicatably connected to the server 2 so that the inputted information is transmitted to the server 2. In the latter case, the server 2 may be configured to have a function of authenticating a user who is trying to access the server 2 to record the above mentioned information.

The server 2 operates to record a user ID of another person in the acquaintance table 42 in response to receipt of the user ID of another person from the portable device 3 of the principal M1, and to record the meeting date and time and the meeting place in response to receipt of data of the meeting date and time and the meeting placed which is transmitted from the potable device 3.

The information disclosure level table 43 includes records 44A, 44B, 44C, . . . , each of which stores an access ID and an information disclosure level. A new record is added to the information disclosure level table 43 each time the server 2 receives an access ID and an information disclosure level from the portable device 3.

Hereafter, various programs stored in the memory 22 of the server 2 are described. The programs include a disclosure range storing program, a meeting data addition program, an acquaintance check program, an acquaintance information search program, and a detailed information transmission program. It should be noted that programs functioning to cause the CPU 21 of the server 2 execute the function of providing various services as a general server are also stored in the memory 2.

The disclosure range storing program causes the server 2 to store an access ID and an information disclosure level (i.e., information representing a disclosure range of information) in the hard disk 4 while associating them with each other, in response to receipt of the access ID and the information disclosure level from one of the portable devices 3. More specifically, when the disclosure range program is executed by the CPU 21 of the server 2, the server 2 operates to add a new record to the information disclosure level table 44 and store the access ID and the information disclosure level in the new record in response to receipt of the access ID and the information disclosure level from one of the portable devices 3.

The meeting data addition program causes the server 2 to add a new record to the meeting table 43 and to record new meeting date and time data and meeting place data in the new record, in response to receipt of the new meeting date and time data and the meeting place data from the portable device 3. More specifically, when executed by the CPU 21, the meeting data addition program causes the server 2 to execute the following process. In response to receipt of various types of information concerning a user ID of a certain user or a user ID of another user from the portable device 3, the server 2 searches the personal table 41 to judge whether a user ID corresponding to the certain user is found in one of the records in the personal table 41. If the server 2 judges that the record of the certain user is found, the server 2 judges whether the user ID of another user is found in one of records of the acquaintance table 42 corresponding to the personal information record of the certain user.

If the server 2 judges that the user ID of another user is found in one of records in the acquaintance table 42, the server 2 operates to add a new record to the meeting table 43 and to record the new meeting date and time data and the meeting place data in the new record of the meeting table 43.

The acquaintance check program causes the server 2 to check whether a user ID of another user is found in the acquaintance table 42 in response to receipt of the user ID of another user from the portable device 3 of the certain user. More specifically, when executed by the CPU 21, the acquaintance check program causes the server 2 to search the acquaintance table 42 associated with the personal information record corresponding to the certain user to find another user's user ID, in response to receipt of the user ID of another user from the portable device 3 of the certain user.

The acquaintance information search program causes the server 2 search the personal table 41 for the personal information record corresponding to the user ID of another user, in response to the face that the acquaintance check program finds the user ID of another user in the acquaintance table 42 corresponding to the certain user. More specifically, when executed by the CPU 21, the acquaintance information search program judges whether the user ID of another user exists in the acquaintance table 42 based on the result of the acquaintance check program, and thereafter searches the personal table 41 for the personal information record corresponding to the user ID of another user if it is judged that the user ID of another user is found in the acquaintance table 42.

The detailed information transmission program is configured such that in response to the fact that the acquaintance information search program finds the personal information record corresponding to the user ID of another user in the personal table 41, the detailed information transmission program causes the server 2 to transmit information in the found personal information record and information in the meeting table 43 corresponding to the user ID of another user associated with the personal information record of the certain user, to the portable device 3 of the certain user.

The detailed information transmission program also causes the server 2 to restrict information concerning the certain user in accordance with the information disclosure level table and to transmit the restricted information concerning the certain user to the portable device of another user, if the server 2 receives a request for business card information of the certain user from the portable device 3 of another user.

More specifically, when executed by the CPU 21, the detailed information transmission program causes the server 2 to operate as follows. The server 2 judges whether the personal information record of another user is found in the personal table 41 based on the search result of the acquaintance information search program. If the server 2 judges that the personal information record of another user is found, the server 2 transmits the information in the found personal information record and information in the meeting table of the user ID of another user associated with the personal information record of the certain user, to the portable device 3 of the certain user.

Information of the memo in the acquaintance record corresponding to the user ID of another user associated with the certain user may be transmitted to the portable device 3 of the certain user, together with the above mentioned information. The server 2 acquires an information disclosure level from the information disclosure level table 44 in accordance with an access ID transmitted from the portable device 3 of another user. In this case, the server 2 acquires restricted information which is obtained from the personal information record corresponding to the certain user based on the user ID of the certain user and is restricted in accordance with the acquired information disclosure level. Then, the server 2 transmits the restricted business card information to the portable device of another user.

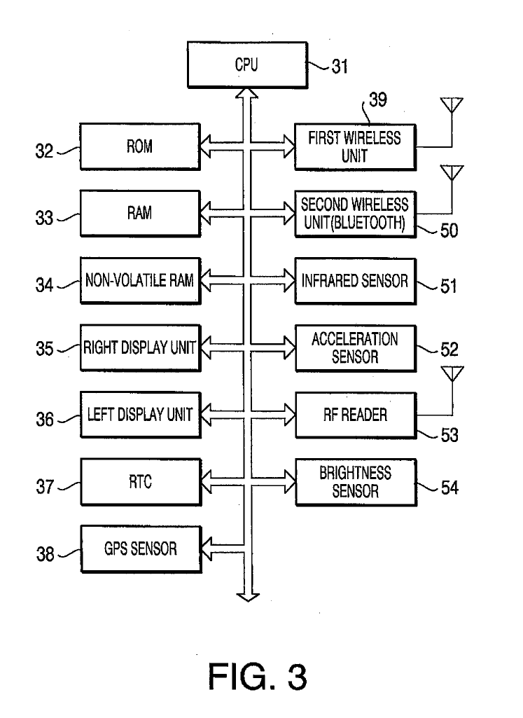

Hereafter, a configuration of the portable device 3 is described. FIG. 3 is a block diagram of a control system of the portable device 3. As shown in FIG. 3, the portable device 3 includes a CPU 31, a ROM 32, a RAM 33, a non-volatile RAM 34, a right display unit 35, a left display unit 36, an RTC (Real Time Controller) 37, a GPS sensor 38, a first wireless unit 39, a second wireless (Bluetooth®) unit 50, an infrared sensor 51, an acceleration sensor 52, an RF reader 53, and a brightness sensor 54.

The CPU 31 executes programs in the ROM 32 to control the functions of the portable device 3. The ROM 32 stores a user ID specific to the portable device 3 and various programs which are described below. The RAM 33 is used as a work memory to store various types of data. The non-volatile RAM 34 stores various types of information including another user's ID, the meeting date and time data, the meeting place data, a secret code for releasing a security lock. It should be noted that the non-volatile RAM 34 has a temporary acquaintance table storing a user ID of another user, a date and time obtained when the user ID of another user is received (i.e., the meeting date and time data), and position information obtained when the user ID of another user is received (i.e., the meeting place data) for each user. Further, the non-volatile RAM 34 has a temporary information disclosure table storing an access ID and an information disclosure level for each user.

Further, the non-volatile RAM 34 stores images of large and small stars used as images representing different types of information.

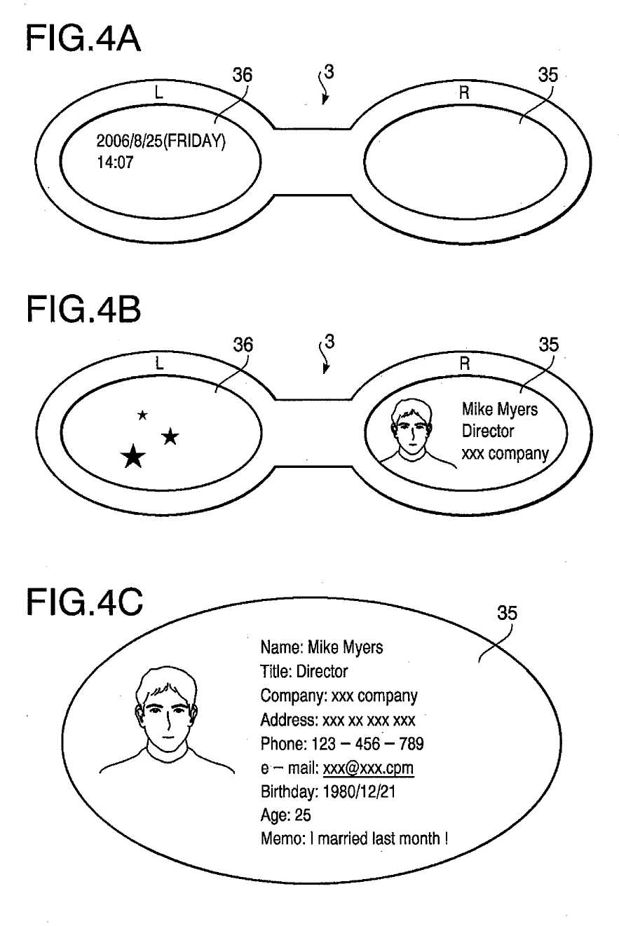

The right display unit 35 is placed on the right side of the portable device 3 (see FIGS. 4A and 4B), and displays a certain type of information as described in detail below. For example, under control of the CPU 31, the right display unit 35 displays part of another user's information stored temporarily in the RAM 33 or remaining detailed information.

The left display unit 36 is placed on the left side of the portable device 3, and displays a certain type of information as described in detail below. For example, under control of the CPU 31, the left display unit 36 displays information such as a date (year/month/day), a time, and a day of the week, or images stored in the non-volatile RAM 34.

The RTC 37 provides time information. The GPS sensor 38 operates to detect a position by receiving GPS signals provided under the Global Positioning System. The first wireless unit 39 is a wireless communication interface capable of performing data communication with the server 2. The second wireless unit 50 provided wireless data communication with another portable device 3 at a predetermined short distance. That is, the second wireless unit 50 is used for short distance data communication. For example, the second wireless unit 50 is based on Bluetooth®.

The infrared sensor 51 is a sensor serving to measure a distance between the portable device 3 and a user with the portable device 3 in the user's hand. The infrared sensor 51 is, for example, a PSD (position sensing detector) which measures a distance from an object based on the fact that a reflection angle of infrared light changes depending on the distance from the object and that the position to which the reflected infrared light impinges on the sensor also changes depending on the distance from the object.

The acceleration sensor 52 is a sensor which detects an acceleration applied to the portable device 3. For example, a sensor formed of a piezoelectric ceramic may be used as the acceleration sensor 52. The RF reader 53 is a device which reads data recorded on RFID (Radio Frequency Identification). The brightness sensor 54 is a sensor which detects a brightness of ambient light. For example, a phototransistor may be used as the brightness sensor 54.

Hereafter, programs stored in the ROM 32 of the portable device 3 are described. As described below, the ROM 32 stores various programs including an ID exchange program, a date and time acquisition program, a meeting data transmission program, a security lock operation registration program, a security lock program, a security lock release program, a handshake judgment program, an information disclosure range selection program, an access ID transmission program, a disclosure request program, a business card information request program, a scooping motion judgment program, a display change program, a display change stop program, a display change restart program, a detail display program and a calibration program.

The ID exchange program causes the portable device 3 to exchange user IDs between the user's portable device 3 and another user's portable device 3, in response to the face that an acceleration detected by the acceleration sensor 52 and the brightness detected by the brightness sensor 54 satisfy a predetermined condition. More specifically, when executed by the CPU 31, the ID exchange program causes the portable device 3 to operate as follows. The portable device 3 compares an acceleration detected by the acceleration sensor 52, a brightness detected by the brightness sensor 54 with predetermined conditions stored in the ROM 32, respectively.

If the portable device 3 judges that the detection results of the acceleration sensor 52 and the brightness sensor 54 satisfy the predetermined conditions, the portable device 3 activates the second wireless unit 50 to transmit a principal ID (i.e., a user ID of the principal) stored in the ROM 32 and to receive the access ID and an user ID of another user from another portable device 3.

Providing of the principal ID for the second wireless unit 50 is executed by the access ID transmission program. More specifically, when executed by the CPU 31, the ID exchange program causes the portable device 3 to load the access ID transmission program and to provide the principal ID and the access ID for the second wireless unit 50.

The date and time acquisition program is a program for acquiring meeting date and time data which corresponds to a date and time when the user IDs are exchanged. More specifically, when executed by the CPU 31, the date and time acquisition program causes the portable device 3 to obtain a date and time from the RTC 37 when the user ID of another user is received by the second wireless unit 50.

The meeting data transmission program is a program for transmitting the user ID of the principal, the user ID of another user, the meeting date and time data and the meeting place data to the server 2 in response to exchange of the user IDs. More specifically, when executed by the CPU 31, the CPU 31 provides the user IF of the principal stored in the ROM 32, the user ID of another user, the meeting date and time obtained from the RTC 37, the position data obtained from the GPS sensor 38 for the first wireless unit 39 in response to receipt of the user ID of another user by the second wireless unit 50.

If data communication with the server 2 is impossible, the CPU 31 temporarily stores the user ID of another user, the meeting date and time data and the meeting place data in the non-volatile RAM 34. When a certain condition is satisfied, the CPU 31 extracts the information (the user ID of another user, the meeting date and time data and the meeting place data) from the non-volatile RAM 34 and the user ID of the principal from the ROM 32, and provides the extracted information for the first wireless unit 39.

The security lock operation registration program causes the portable device 3 to calculate a plurality of pairs of a position of the portable device 3 and a time when the portable device 3 arrives at the position, and to store the plurality of pairs of the position and the time in the non-volatile RAM 34. The “position” to be calculated us a position defined with respect to an original which is defined as a position of the portable device 3 determined when the security lock operation registration program starts. That is, the plurality of pairs of position and the time define a plurality of points on a locus of movement of the portable device 3.

More specifically, when executed by the CPU 31, the security lock operation registration program causes the portable device 3 to obtain an acceleration detected by the acceleration sensor 52 and the time from the RTC 37. Then, the portable device 3 calculates the position and the time (i.e., the arrival time) based on the obtained acceleration and the time, and stores the position and the time in the non-volatile RAM 34 as secret information.

The security lock program is a program for inhibiting an operation of the portable device 3 when a predetermined condition is satisfied. The predetermined condition is, for example, registration of a security lock operation, a lapse of a constant time in a non-operation state, a predetermined type of motion of the portable device 3 or pressing of a certain button. More specifically, when executed by the CPU 31, the security lock operation registration program causes the portable device 3 to judge whether the predetermined condition is satisfied, and to move to a state where the portable device does not execute other processes if the predetermined condition is satisfied.

The security lock release program causes the portable device 3 to a plurality of pairs of a position of the portable device 3 and a time when the portable device 3 arrives at the position based on an acceleration detected by the acceleration sensor 52, and to release the locked state where operations of the portable device 3 is inhibited when the calculated plurality of pairs of a position and a time are equal to the secret information in the non-volatile RAM 34. More specifically, the portable device 3 makes a comparison in such a manner that when a calculated position corresponding to a certain arrival time is within a certain distance from the position of the secret information corresponding to the certain arrival time, the portable device 3 judges that the calculated position and time are equal to the corresponding position and time of the secret information.

More specifically, when executed by the CPU 31, the security lock release program causes the portable device 3 to operate as follows. The CPU 31 obtains an acceleration detected by the acceleration sensor 52 and the time from the RTC 37. Then, the CPU 31 calculates the position and arrival time based on the obtained acceleration and time, and compares the calculated position and the arrival time with the secret information in the non-volatile RAM 34. In this case, the CPU 31 obtains distance information stored in advance in the non-volatile RAM 34.

Next, the CPU 31 judges whether a calculated position corresponding to a certain arrival time is within a certain distance (corresponding to the obtained distance information) from the position of the secret information corresponding to the certain arrival time. If the calculated position is within the certain distance, the CPU 31 operates to releases the locked state where operation of the portable device 3 is inhibited. If the calculated position is not within the certain distance, the CPU 31 operates to keep the locked state of the portable device 3.

The handshake judgment program is a program for determining the number of times of handshake by counting the number of times that the portable device is shook. More specifically, when executed by the CPU 31, the handshake judgment program causes the portable device 3 to obtain an acceleration detected by the acceleration sensor 52, and to count the number of times where the direction of the acceleration switches from the downward direction to the upward direction so that the number of times of handshake can be obtained. Then, the portable device 3 temporarily stores the counted number of times of handshake in the RAM 33.

The information disclosure range selection program is a program for enabling the user (i.e, the principle M1) to select the disclosure range of the business card information when the user (the principal M1) is required instant reaction in a situation where the user ID of the principal used for disclosure of the business card information of the principal M1 is transmitted from the portable device 3 of the principal M1 to the portable device 3 of another person M2.

More specifically, when executed by the CPU 31, the information disclosure range selection program causes the portable device to operate as follows. First, the CPU 31 judges whether the number of times of handshake is stored in the RAM 33. If at least the number of times of handshake representing one time of handshake is stored, the CPU 31 makes a selection on the information disclosure level. If the CPU 31 judges the number of times of handshake to be one time, the CPU 31 defines the information disclosure level as “Low”. If the CPU 31 judges the number of times of handshake to be two times, the CPU 31 defines the information disclosure level as “Middle”. If the CPU 31 judges the number of times of handshake to be three times, the CPU 31 defines the information disclosure level as “High”. That is, the CPU 31 increases the range of information disclosure as the number of times of handshake increases.

The access ID transmission program is a program for transmitting an access ID corresponding to the information disclosure level to the portable device 3 of another person M2 together with the user ID of the principal when the user IDs are exchanged. More specifically, when executed by the CPU 31, the access ID transmission program causes the CPU 31 to select the information disclosure level, to create an access ID relating to the information disclosure level, to obtain the user ID of the principal from the ROM 32, and to provide the user ID of the principal and the access ID for the second wireless unit 50.

The access ID is unique information and is created, for example, based on the time information provided by the RTC 37. The access ID is associated with the information disclosure level so as to allow a certain user to access the server 2 and to refer to information in the personal table 41 of another user.

The disclosure request program is a program for transmitting the access ID and the information disclosure level generated by the certain user's own portable device 3 to the server 2. More specifically, when executed by the CPU 31, the disclosure request program causes the CPU 31 to provide the access ID and the information disclosure level for the first wireless unit 39 in response to completion of the selection of the information disclosure level and the generation of the access ID.

The business card information request program is a program for requesting transmission of the business card information of a certain user by transmitting a user ID and an access ID received from the certain user. More specifically, when executed by the CPU 31, the business card information request program causes the CPU 31 to provide an access ID and a use ID of a certain user for the first wireless unit 39 in response to receipt of the user ID and the access ID from the portable device 3 of the certain user.

The scooping motion judgment program is a program for judging whether a scooping motion for scooping a star image displayed on the left display unit 36 is conducted by a user with the left display unit 36 of the portable device 3. More specifically, when executed by the CPU 31, the scooping motion judgment program causes the CPU 31 to obtain an acceleration detected by the acceleration sensor 52 and to judge whether the scooping motion is conduced based on the obtained acceleration.

The display change program is a program for reading part of time-series information from the server in accordance with the distance detected by the infrared sensor 51, and for outputting the obtained part of the time-series information on the right display unit 35. In this case, the CPU 31 obtains part of the time-series information such that the larger the distance detected by the infrared sensor 51 becomes, the older the part of the time-series information obtained by the CPU 31 becomes.

Further, the display change program outputs, on the left display unit 36, a star image corresponding to the part of the time-series information displayed on the right display unit 35. The display change program displays, on the right display unit 35, detailed information corresponding to the obtained part of the time-series information in response to detection of the scooping motion by the scooping motion judgment program.

More specifically, when executed by the CPU 31, the display change program causes the CPU 31 to operate as follows. The CPU 31 obtains the distance detected by the infrared sensor 51, and to store the distance and the time when the distance is obtained in a predetermined area of the RAM 33 such that the obtained distances and the times are recorded in proper time sequence. Then, the CPU 31 figures out a search parameter by obtaining a predetermined expression stored in advance in the ROM 32 and the distance and the time stored in the RAM 33 and performing a computation on the obtained expression and the obtained information.

Next, the CPU 31 makes a comparison between the search parameter and the time-series information stored in the server 2, extracts part of the time-series information close to the search parameter, and then displayed the extracted information on the right display unit 35.

Further, the CPU 31 calculate a difference between the search parameter and each piece of information in the time-series information so that star images respectively corresponding to the calculated differences are selected from the non-volatile RAM 34 and the selected star images are displayed on the left display unit 36. In this case, selection of star images are made by the CPU 31 such that the smaller the distance becomes, the larger the star image becomes. If the judgment result of the scooping motion judgment program shows that the scooping motion is conduced by a user, the CPU 31 displays, on the right display y unit 35, detailed information of the time-series information stored in the server 2.

The display change stop program is a program for stopping change of the time-series information displayed by the display change program in accordance with the input to the portable device 3. More specifically, when executed by the CPU 31, the display change stop program causes the CPU 31 to obtain an acceleration detected by the acceleration sensor 52, and to judge whether a stop command for stopping change of the displayed information by judging whether the direction of acceleration switches from the downward direction to the upward direction. If the CPU 31 judges that the stop command is inputted, the CPU 31 exhibits execution of the display change program so that the images on the right and left display units 35 and 36 are fixed.

The display change restart program is a program for restarting change of the information displayed by the display change program in accordance with the input to the portable device 3. More specifically, when executed by the CPU 31, the display change restart program causes the CPU 31 to obtain an acceleration detected by the acceleration sensor 52, and to stop execution of the display change stop program and to restart the display change program, for example, when the change of acceleration corresponds to a motion where the left display unit 36 is flipped from the upward orientation to the downward orientation.

The detail display program is a program for displaying information of the personal table 41, the acquaintance table 42 and the meeting table 43 transmitted from the server 2. More specifically, when executed by the CPU 31, the detail display program causes the CPU 31 to generate image data based on the information received by the first wireless unit 39 and to display an image corresponding to the image data on the right display unit 35.

The calibration program is a program for calibrating relationship between the length of the user's arm and the amount of the time-series information. More specifically, when executed by the CPU 31, the calibration program causes the CPU 31 to search for the oldest meeting date and time from the meeting date and time data stored in the server 2, to obtain the current time from the RTC 37, and to calculate a difference between the current time and the oldest meeting date and time.

Then, the CPU 31 calculates a difference between the current distance detected by the infrared sensor 51 and a predetermined minimum value of distance information. Next, the CPU 31 calculates a conversion coefficient by dividing the calculated time difference by the calculated distance difference, and then adjusts the relationship between the amount of the time-series information and the length of the user's arm using the conversion coefficient.

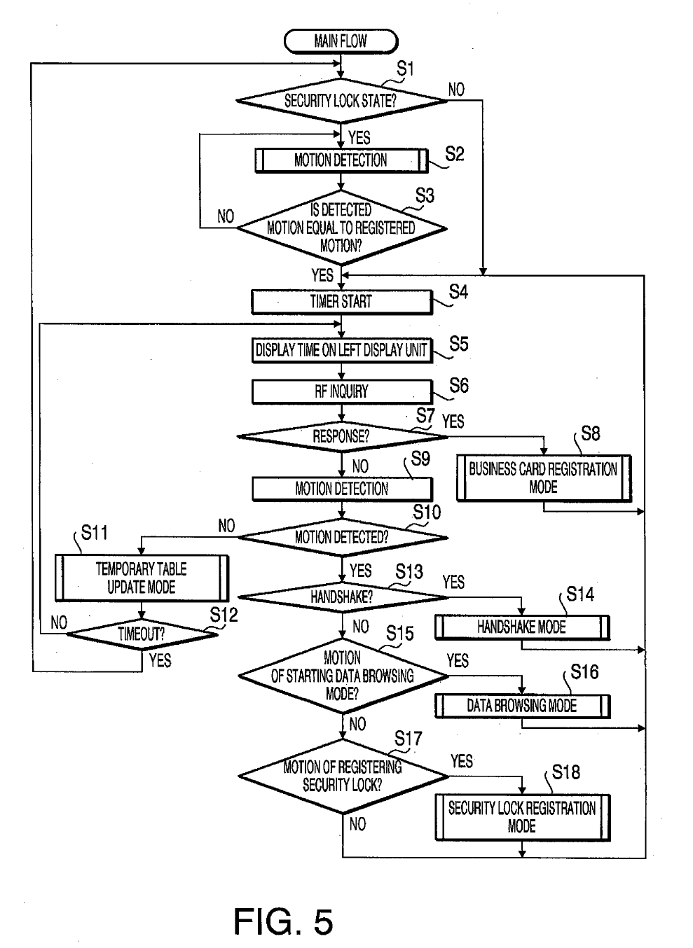

Operations of the portable device 3 will now be described. FIG. 5 is a flowchart illustrating a main process executed under control of the CPU 31 of the portable device 3 to control the internal components. First, the CPU 31 judges whether the portable device is in a security lock state (step S1). As described in detail below, motion information representing motion of the portable device 3 is employed as secret information to be used for the security lock.

If the portable device 3 is in the security lock state (S1: YES), motion of the portable device is checked in step S2. In step S2, accelerations are detected by the acceleration sensor 52 while the user (the principal M1) moves the portable device 3 by hand to impart a predetermined motion to the portable device 3. The predetermined motion is, for example, a revolution. Such a motion can be produced by the user by rotating the user's arm with the portable device in the user's hand.

If a security lock registration mode process (step S18) has been properly executed, the judgment result of step S1 is “YES”. On the other hand, if the security lock mode process has not been executed, or if the security lock function is set to “off” by a certain motion imparted to the portable device 3 in the case where the security lock mode process has been properly process, the judgment result of step S1 is “NO”.

After the motion (i.e., positions and arrival times) of the portable device 3 is checked in step S2, the CPU 31 compares the motion of the portable device 3 with the motion (positions and arrival times) which has been registered in the non-volatile RAM 34. In step S3, the CPU 31 judges whether the motion detected in step S2 is equal to the motion registered in the non-volatile RAM 34. As described above, the CPU 31 judges that the detected motion is equal to the registered motion 34 if the difference between the detected motion and the motion in the non-volatile RAM 34 is within a certain error range. If the CPU 31 judges that the detected motion is not equal to the registered motion (S3: NO), control returns to step S2.

If the CPU 31 judges that the detected motion is equal to the registered motion (S3: YES), time counting is started based on time information provided by the RTC 37 (step S4). Then, the CPU 31 displays a date, a day of the week and the time on the left display unit 36 as shown in FIG. 4A (step S5).

Next, the CPU 31 controls the RF reader 53 to transmit a wireless signal to request a response from an RFID in the vicinity of the portable device 3 (step S6). In step S7, the CPU 31 judges whether a response is received from the RFID. If it is judged that a response is received (S7: YES), the CPU 31 causes the portable device 3 to move to a business card registration mode (step S8). The business card registration mode is a process executed when a person with whom the user (the principal M1) of the portable device 3 holds a meeting does not have a portable device 3 but has a name card (e.g., a paper name card) with an RFID storing business card information. For example, if the user (the principal M1) receives a name card with an RFID from the other person in the meeting and a response is transmitted from the name card with the RFID to the user's portable device 3, a process of the business card registration mode is executed (step S8).

If no response is received in step S7 (S7: NO), detection of a motion of the portable device 3 by the acceleration sensor 52 is performed (step S9). Then, the CPU 31 judges whether a motion of the portable device 3 is detected (step S10).

If no motion is detected (S10: NO), the CPU 31 causes the portable device 3 to move to a temporary table update mode (step S11). After the portable device 3 exits from the temporary table update mode, the CPU 31 judges whether a timeout occurs by judging whether a predetermined time elapsed from the start time of the timer in step S4 (step S12). If a timeout occurs (S12: YES), control returns to step S1. If a timeout does not occur (S12: NO), control returns to step S5.

If it is judged that a motion is detected (S10: YES), the CPU 31 judges whether the detected motion corresponds to a handshake motion (step S13). If the detected motion corresponds to a handshake motion (S13: YES), the CPU 31 causes the portable device 3 to move to a handshake mode (step S14). If the detected motion does not correspond to the handshake motion (S13: NO), control proceeds to step S15.

In step S15, the CPU 31 judges whether the detected motion corresponds to a motion for initiating a data browsing mode (hereafter, referred to as a browsing start motion). The browsing start motion is, for example, a motion where the user gives a slight shock to the portable device 3. Such a slight shock to the portable device can be produced by tapping a table with the portable device 3.

If the CPU 31 is judges that the detected motion corresponds to the browsing start motion (S15: YES), the CPU 31 causes the portable device 3 to move to the data browsing mode (step S16). If the detected motion does not correspond to the browsing start motion (S15: NO), control proceeds to step S17.

In step S17, the CPU 31 judges whether the detected motion corresponds to a motion for registering secret information for security lock (hereafter, referred to as a registration motion). For example, the registration motion is a motion like a locking motion. Such a locking motion is produced by turning the portable device 3 a half of a turn in a clockwise direction. If the detected motion corresponds to the registration motion (S17: YES), the CPU 31 causes the portable device 3 to move to a security lock registration mode (step S18). If the detected motion does not correspond to the registration motion (S17: NO), control returns to step S4.

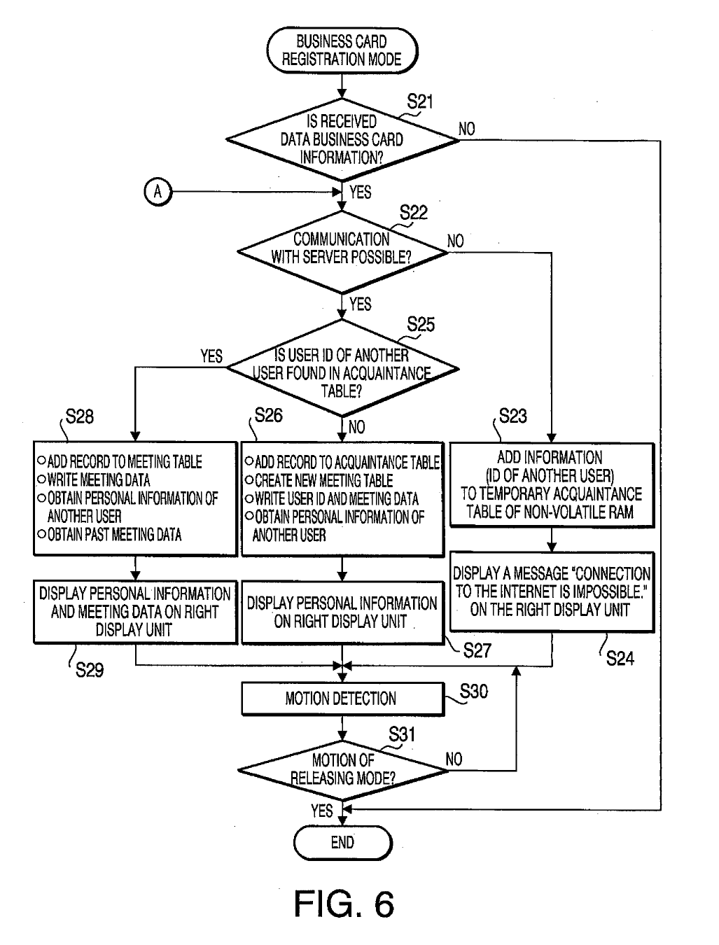

FIG. 6 is a flowchart illustrating a process of the business card registration mode. When the business card registration mode is initiated, the CPU 31 judges whether the data received by the RF reader 53 corresponds to the business information containing a user ID of another user (step S21). If the received data does not correspond to the business card information (S21: NO), the process of the business card registration mode terminates.

If the received data corresponds to the business card information (S21: YES), control proceeds to step S22 where the CPU 31 judges whether data communication with the server 2 is possible. If data communication with the server 2 is impossible (S22: NO), the CPU 31 adds the received user ID on another user, the meeting date and time data, and the meeting place data to the temporary acquaintance table in the non-volatile RAM 34 (step S23). Then, the CPU 31 displays a message “Connection to the Internet is impossible.” on the right display unit 35 (step S24).

If data communication with the server 2 is possible (S22: YES), the CPU 31 judges whether the received user ID of another user is found in the acquaintance table 42 in the server 2 (step S25). If the CPU 31 judges that the user ID of another user is not found in the acquaintance table 42 (S25: NO), control proceeds to step S26. More specifically, in step S25, the portable device 3 transmits the user if of the principal and the user ID of another user to the server 2, and the server 2 judges whether the acquaintance table 42 contains the user ID of another user based on the user ID of the principal and the user ID of another user transmitted from the portable device 3. This judgment is made by judging whether the acquaintance table 42 associated with the personal information record in the personal table 41 designated by the user ID of the principal contains the acquaintance record including the user ID of another user. The access ID is also transmitted to the server 2, together with the user ID of the principal and the user ID of another user.

In step S26, a new acquaintance record is added to the acquaintance table 42 associated with the record of the personal table 41 corresponding to the principal M1, and a meeting table 43 is created in association with the newly added acquaintance record. Then, the user ID of another user is stored in the new acquaintance record. Further, meeting data (a date and time) generated based on information provided by the RTC 37 and the GPS sensor 38 is added in a first record in the newly generated meeting table 43. The personal table 41 is searched to find the personal information record corresponding to the user ID of another user M2, and personal information of another user M2 is obtained form the found record.

It should be noted that the personal information of another user M2 is restricted to a predetermined range of disclosure defined by the information disclosure level in the information disclosure level table 44 specified by the access ID transmitted together with the user ID of the principal and the user ID of another user. In this case, the information disclosure level for another person M2 is defined in the portable device 3 of another user M2.

More specifically, if the information disclosure level is “High”, all the information in the personal information record of another user M2 in the personal table 41 is transmitted from the server 2 to the portable device 3. if the information disclosure level is “Middle”, information corresponding to “-name”, “-title”, “-organization”, “-organization unit”, “-address”, “-phone”, “-e-mail” is transmitted from the server 2 to the portable device 3. If the information disclosure level is “Low”, the information defined by excluding information of “-phone” and “-e-mail” from the information corresponding to the information disclosure level of “Middle” is transmitted from the server 2 to the portable device 3.

After step S26 is thus processed, the personal information obtained in step S26 is displayed on the right display unit 35 as shown in FIG. 4C (step S27).

If it is judged in step S25 that the user ID of another user is found in the acquaintance table 42 (S25: YES), control proceeds to step S28. In step S28, a new meeting record is added to the meeting table 43 which has been already created in association with the acquaintance record 42. then, the meeting data is added to the new meeting record. The personal table 41 is searched to find the personal information record corresponding to another user M2, and the personal information is obtained from the found personal information record. It should be noted that the personal information of another user M2 is restricted to a predetermined range of disclosure defined by the portable device 3 of another user M2. The past meeting data in the meeting table 43 created in association with the acquaintance record of the acquaintance table 42 corresponding to the user ID of another user is also obtained.

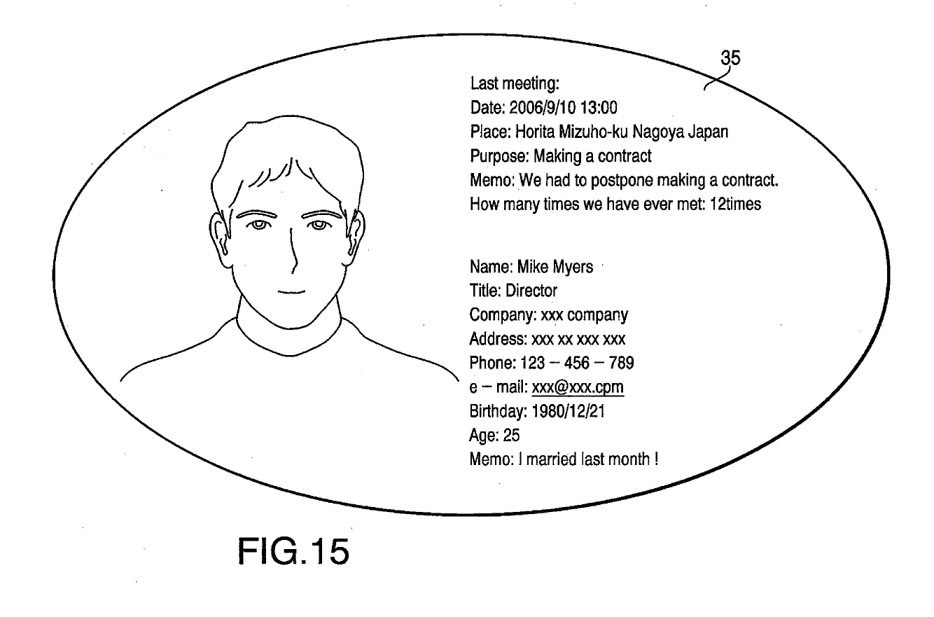

After step S28 is processed, the personal information obtained in step S28 is displayed on the right display 35 as shown in FIG. 15. In FIG. 15, “Last meeting: Date: Sep. 10, 2006” is the latest meeting date and time data in the meeting table 43. The information recorded in the meeting record corresponding to the latest meeting date and time data is displayed as items “Place”, “Purpose” and “Memo”. The total number of records in the meeting table 43 of another user associated with the personal table 41 corresponding to a certain user is displayed as a message “How many times we have ever met: 12 times”.

A portrait and information of items from “Name” to “Birthday” and “Memo” prepared based on the information stored in the record of the personal table 41 corresponding to another user searched for by the acquaintance information search program, and the portrait and the prepared information is displayed. In this case, the age is calculated based on the “Birthday” and the current time. “My memo” is displayed based on the memo stored in the acquaintance table 42. The portable device 3 may be configured such that items to be displayed can be selected. The above mentioned explanations about the items can be applied to the same items illustrated in FIG. 4C.

After step S24, S27 or S29 is processed, the motion detection by the acceleration sensor 52 is performed (step S30). Then, in step S31, the CPU 31 judges whether the detected motion of the portable device 3 corresponds to a motion for releasing the business card registration mode (hereafter, referred to as a mode release motion). The mode release motion is, for example, a motion where the user throws away information displayed on the right display unit 35. Such a motion can be produced by flipping vertically the right display unit 35 from top to bottom.

If the detected motion does not correspond to the mode release motion (S31; NO), control returns to step S30. If the detected motion corresponds to the mode release motion (S31; YES), the process of the business card registration mode terminates.

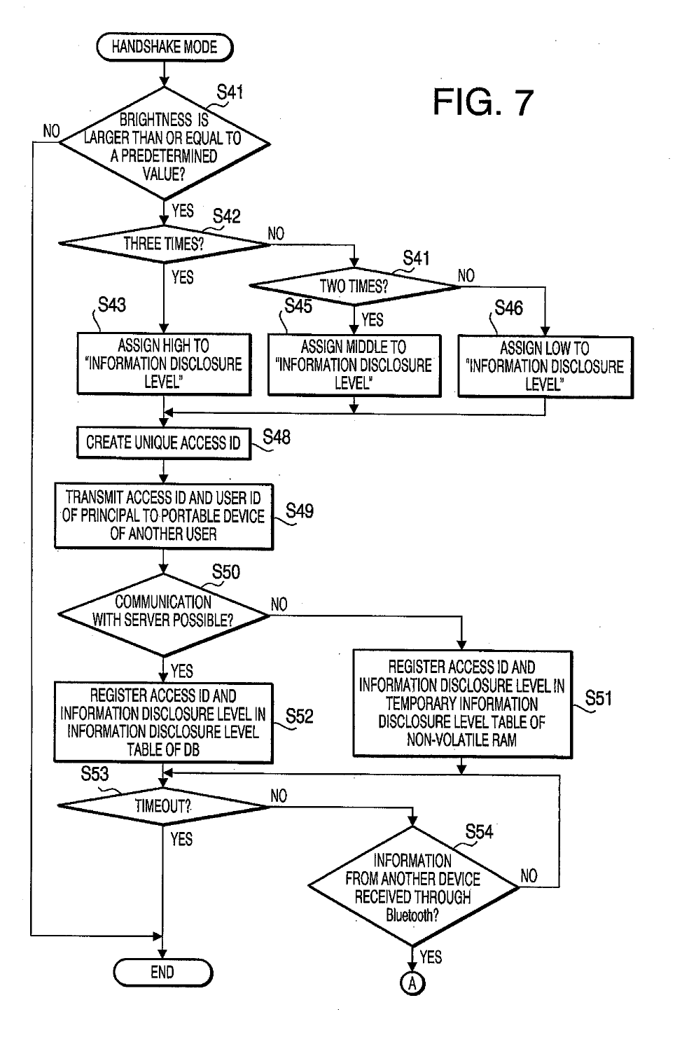

FIG. 7 is a flowchart illustrating a process of the handshake mode executed in step S14 of the main process. When the handshake mode is initiated, the CPU 31 judges whether the brightness detected by the brightness sensor 54 is larger than or equal to a predetermined value (step S41). If the detected brightness is smaller than the predetermined value (S41: NO), the process of the handshake mode terminates. If the detected brightness is larger than or equal to the predetermined value (S41: YES), control proceeds to step S42.

In step S42, the CPU 31 judges whether the number of times of handshake is equal to three. If the number of times of handshake is three (S42: YES), the information disclosure level is defined as “High”. Then, control proceeds to step S48. If the number of times of handshake is not three (S42: NO), the CPU 31 judges whether the number of times of handshake is equal to two (step S44). If the number of times of handshake is equal to two (S44: YES), the CPU 31 defined the information disclosure level as “Middle” (step S45). Then, control proceeds to step S48.

If the number of times of handshake is not equal to two (S44: NO), the CPU 31 defined the information disclosure level as “Low” (step S46). Then, control proceeds to step S46.

In step S48, a unique access ID is created. Then, the user ID of the principal and the access ID are provided for the second wireless unit 50 so that the user ID of the principal and the access ID is transmitted to the portable device 3 of another user M2 in wireless communication based on Bluetooth® (step S49).

Next, the CPU 31 judges whether data communication with the server 2 is possible (step S50). If the data communication with the server 2 is impossible (S50: NO), the access ID and the information disclosure level are added to the temporary information disclosure table (step S51).

If the data communication with the server 2 is possible (S50: YES), the access ID and the information disclosure level are registered in the information disclosure level table 44 of the server 2 (step S52).

After the access ID and the information disclosure level are thus registered in the information disclosure level table 44, personal information of the principal M1 is restricted in accordance with the information disclosure level of the principal M1 when another person M2 accesses the server 2 from the portable device 3 of another user M2 to get personal information of the principal M1. More specifically, the server 2 obtains the information disclosure level corresponding to the received access ID from the information disclosure level table 44 in response to receipt of the user ID of the principal and the access ID from the portable device 3 of another user M2.

Then, the server 2 extracts the personal information corresponding to the obtained information disclosure level from the personal information record 41A of the personal table 41, and transmits the information to the portable device 3 on another user M2.

After step S51 or S52 is processed, the CPU 31 judges whether a timeout occurs by judging whether a predetermined time has elapsed from the start of the timer in step S4 (step S53). If a timeout occurs (S53: YES), the process of the handshake mode terminates. If a timeout does not occur (S53: NO), control proceeds to step S54.

In step S54, the CPU 31 judges whether the second wireless unit 50 receives information (the user ID and the access ID) from the portable device 3 of another user. If the information is not received from the portable device 3 of another user (S54: NO), control returns to step S53. If the information is received from the portable device 3 of another user (S54: YES), control proceeds to step S22 (see FIG. 6) of the business card registration mode.

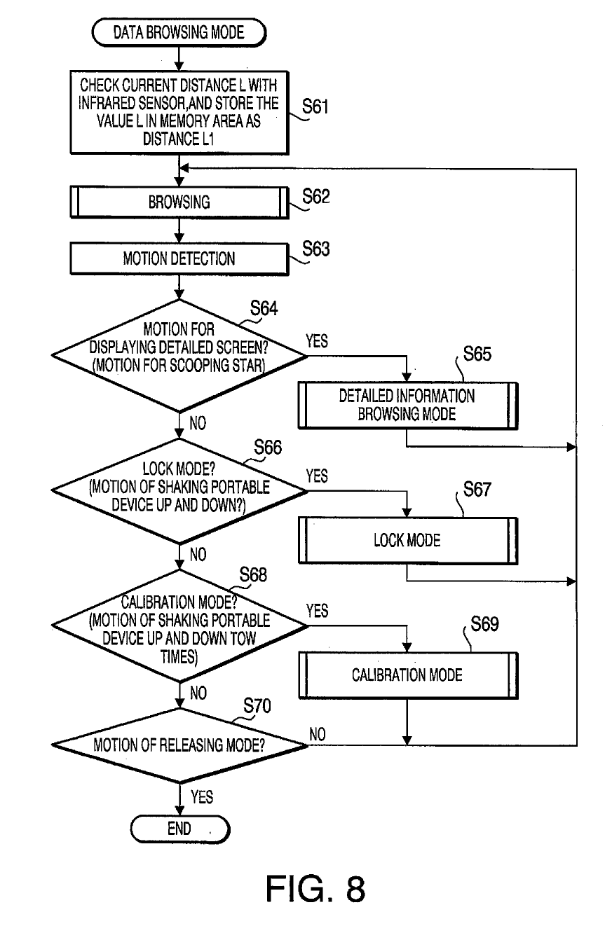

FIG. 8 is a flowchart illustrating a process of the data browsing mode executed in step S16 of the main process. As described above, the data browsing mode is initiated by giving a slight shock to the portable device 3. First, the CPU 31 controls the infrared sensor 51 to obtain a current distance L (which is distance between the user and the portable device 3 when a slight shock is given to the portable device 3 or when a certain time elapses from the time when a slight shock is given to the portable device 3. Then, the current distance L (L1) is stored in a current distance memory area in the RAM 33.

After step S61 is processed, the CPU 31 causes the portable device 3 to move to a browsing mode. The browsing mode is a mode where the user browses the information displayed on the display unit 35 or 36 while changing the information to be displayed on the right display unit 35 and the left display unit 36. by moving the portable device 3 toward or away from the user. In this case, the information is displayed on the portable device 3 such that the larger the distance between the portable device 3 and the user becomes, the older the displayed information becomes, and that the shorter the distance between the portable device 3 and the user becomes, the newer the displayed information becomes.

After the portable device 3 exits the data browsing mode, a motion of the portable device is detected by the acceleration sensor 52 (step S63). Then, the CPU 31 judges whether the detected motion corresponds to a motion for displaying detailed information (step S64). The motion for displaying detailed information is, for example, a scooping motion where the user scoops a star image displayed on the left display unit 36 with the portable device 3 in the user's hand.

If the detected motion corresponds to the motion for scooping a star image (S64: YES), the CPU 1 causes the portable device 3 to move to a detailed data browsing mode (step S65). If the detected motion does not correspond to the motion for scooping a star image (S64: NO), control proceeds to step S66. The detailed data browsing mode is a mode where the user is able to brows details of the brief information provided by the browsing mode. After the detailed data browsing mode is processed, control returns to step S62.

In step S66, the CPU 31 judges whether the detected motion corresponds to a motion for locking the displayed information on each of the display units 35 and 36. The motion for locking the displayed information is, for example, one reciprocating motion produced by shaking the portable device 3 in the vertical direction by hand.

If the detected motion corresponds to the locking the displayed information (S66: YES), control proceeds to step S67 where the CPU 31 causes the portable device 3 to move to a lock mode. If the detected motion does not correspond to the locking the displayed information (S66: NO), control proceeds to step S68. The lock mode is a mode where change of the displayed information in the browsing mode is inhibited. More specifically, when the user fully stretches the user's arm with the portable device 3 in the user's hand and thereby the browsing of the still older information becomes impossible, the use is able to lock the displayed state of the each of the display units 35 and 36 through the lock mode. Then, the user brings the user's hand near to the user's body to release the lock mode. As a result, the user is able to brows the still older information be stretching the user's arm. After the lock mode is processed, control returns to step S62.

In step S68, the CPU 31 judges whether the detected motion corresponds to a motion for performing calibration. The motion for performing calibration is, for example, two reciprocating motions produced by shaking the portable device 3 in the vertical direction by hand.

If the detected motion corresponds to the motion for performing calibration (S68: YES), the CPU 31 causes the portable device 3 to move to a calibration mode (step S69). If the detected motion does not correspond to the motion for performing calibration (S68: NO), control proceeds to step S70. In the calibration mode, a relationship between the length of the user's arm and the amount of data is adjusted. For example, the relationship is adjusted such that the oldest data is displayed when the user fully stretches the user's are with the portable device 3 in the user's hand (i.e., when the portable device 3 is situated at the furthest position from the user's body, and that the latest information is displayed when the portable device 3 is brought to the nearest position with respect to the user's body (i.e., the portable device 3 is at the minimum distance Lmin from the user's body). After the portable device 3 exits the calibration mode, control returns to step S62.

In step S70, the CPU 31 judges whether the detected motion corresponds to a motion for releasing the data browsing mode, the motion for releasing the data browsing mode is, for example, a motion where the user throws away information displayed on the left display unit 36. Such a motion can be produced by flipping vertically the left display unit 36 from top to bottom. If the CPU 31 judges that the detected motion does not correspond to the motion for releasing the data browsing mode (S70: NO), control returns to step S62. If the CPU 31 judges that the detected motion corresponds to the motion for releasing the data browsing mode (S70: YES), the process of the data browsing mode terminates.

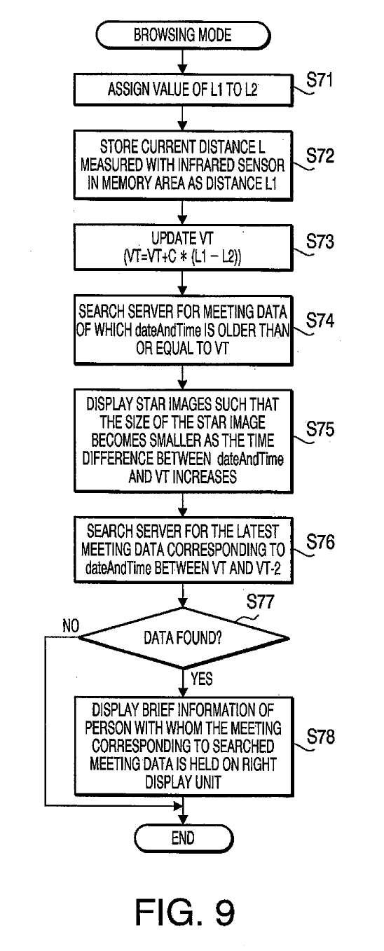

FIG. 9 is a flowchart illustrating a process of the browsing mode executed in step S62. If a motion of the portable device 3 with respect to the position corresponding to the current distance L1 (measured in step S61), a distance of a new position to which the portable device has moved is measured, and the current distance L1 stored in a current distance memory area is written to a previous distance memory area of the RAM 33 as a previous distance L2 (step S71). Then, the newly measured distance (a current distance L) is written to the current distance memory area as a current distance L1 (step S72).

If the detected current distance L is smaller than the predetermined minimum distance Lmin, the minimum distance Lmin is written as a current distance L1.

After step S72 is processed, the CPU 31 updates a search parameter VT stored in a predetermined memory area in the RAM 33 (step S73). The search parameter is a parameter for searching for required meeting date and time data. In step S73, the search parameter is calculated by the following equations (1) and (2):
VT=VT′+α (1)
α=C×(L1−L2) (2)
where VT′ represents a previous search parameter, α represents a display change parameter, and C represents a conversion parameter.

As expressed by the equation (1), the search parameter VT is obtained by adding the display change parameter α to the previous search parameter VT′. As expressed by the equation (2), the display change parameter α is obtained by multiplying a difference between the current distance L1 and the previous distance L2 by the conversion parameter C. As described later, the conversion parameter is determined in the calibration mode.

After step S73 is processed, the CPU 31 searches the meeting table 43 of the server 2 for the meeting date and time data of which meeting date and time (DateAndTime) is older than or equal to the time represented by the search parameter VT (step s74). If a plurality of pieces of meeting date and time information exists in one meeting table 43, the search process in step S74 is executed in order where the newer information is preferentially searched so that the CPU 31 moves to a search operation for another meeting table immediately when the data satisfying the condition is found. In this case, it is possible to prevent the data of the same person being found in the browsing.

If a plurality of pieces of meeting date and time data alder than or equal to the search parameter VT is found, star images respectively corresponding to the searched plurality of pieces of data are obtained from the non-volatile RAM 34, and are displayed on the left display unit 36 (step S75). The star images are selected such that the size of the star image becomes larger as a time difference between the meeting date and time data and the search parameter VT decreases, and that the size of the star image becomes smaller as the time difference between the meeting date and time data and the search parameter VT increases (see FIG. 4B).

After step S75 is processed, the CPU 31 searches the meeting table 43 of the server 2 for the meeting date and time data of which date and time lies within the date and time represented by the search parameter VT and the date and time two days before the date of the search parameter VT. That is, the meeting date and time data from VT to (VT-2 days) is searched for.

In step S77, the CPU 31 judges whether at least a piece of meeting date and time data from VT to (VT-2 days) is found. If at least a piece of meeting date and time data from VT to (VT-2 days) is found (S77: YES), brief information (e.g., a name and a company name) of another person corresponding to the searched meeting date and time is displayed on the right display unit 35 (step S78) as shown, for example, in FIG. 4B. Then, the process of the browsing mode terminates.

If no meeting date and time data from VT to (VT-2 days) is found (S77: NO), the browsing mode terminates. It should be noted that if no meeting date and time data from VT to (VT-2 days) is found, no data is displayed on the right display unit 35. In this case, it is understood that no meeting is held at the date and time represented by the search parameter VT which corresponds to the current position of the portable device 3 with respect to the user.

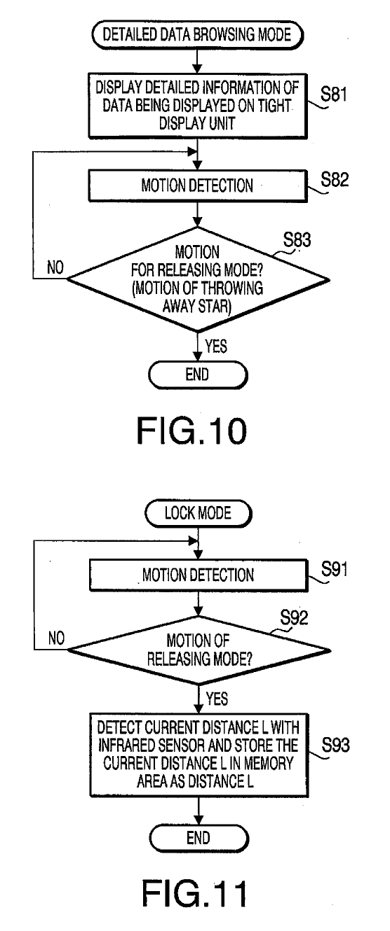

FIG. 10 is a flowchart illustrating a process of the detailed data browsing mode. First, the CPU 31 replaces the brief information of the user currently displayed on the right display unit 35 with the detailed information (i.e., the personal information obtained from the personal table 41) obtained from the server 2 (step S81) (see FIG. 4B for the brief information and FIG. 4C for the detained information).

After step S81 is processed, the CPU 31 controls the acceleration sensor 52 to detect a motion of the portable device 3 (step S82). Then, the CPU 31 judges whether the detected motion corresponds to a motion for releasing the detailed data browsing mode (step S83). The motion for releasing the detailed data browsing mode is, for example, a motion where the user throws away a star image displayed on the left display unit 36 with the portable device 3 in the user's hand. Such a motion may be produced by flipping vertically the left display unit 36 from top to bottom.

If the detected motion does not correspond to the motion for releasing the detailed data browsing mode (S83: NO), control returns to step S82. If the detected motion corresponds to the motion for releasing the detailed data browsing mode (S83: YES), the detailed data browsing mode terminates. That is, the detailed information keeps the detailed information displayed on the right display unit 35 unless the user produces the motion for throwing away the star image on the right display unit 35.

FIG. 11 is a flowchart illustrating a process of the lock mode. First, the CPU 31 controls the acceleration sensor 52 to detect a motion of the portable device 3 (step S91). Then, the CPU 31 judges whether the detected motion corresponds to a motion for releasing the lock mode (step S92). The motion for releasing the lock mode is, for example, a motion for throwing away a star image displayed on the left display unit 36.

If the detected motion does not correspond to the motion for releasing the lock mode ((S92: NO), control returns to step S91. That is, the displayed information on the display units 35 and 36 is not changed even if the portable device 3 is move back and forth because the portable device 3 stays in the lock mode and does not move to the browsing mode unless the user moves the portable device 3 to throw away the star image.

If the detected motion corresponds to the motion for releasing the lock mode ((S92: YES), a distance (i.e., the current distance) between the user and the portable device 3 is measured, and measured distance L is stored in the current distance memory area as a current distance L1 (step S93). After step S93 is processed, the process of the lock mode terminates.

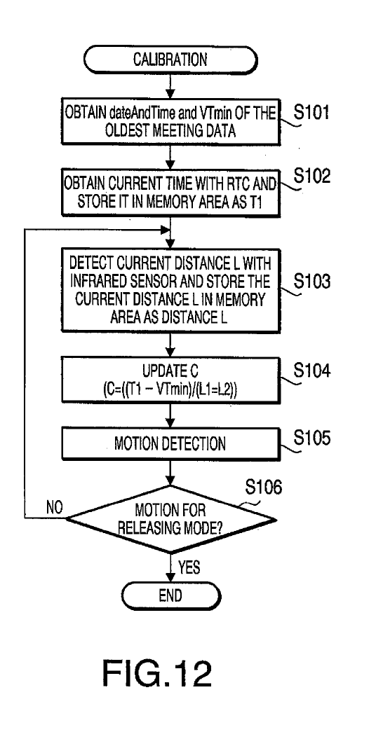

FIG. 12 is a flowchart illustrating a process of the calibration mode. First, the CPU 31 obtains the oldest meeting date and time data from the plurality of pieces of meeting date and time data in each of the meeting tables 43 in the server 2, and the date and time corresponding to the oldest meeting date and time data is assigned to a variable VTmin of the search parameter VT (step S101).

Then, the current time T is obtained from the RTC 37, the current time T is stored in the current time memory area as a current time T1 (step S102). Then, the current distance L is measured by the infrared sensor 51, and the measured distance L is stored in the current distance memory area as a current distance L1 (step S103). When the portable device 3 enters the calibration mode, the user fully stretches the user's arm. Therefore, measured current distance L corresponds to the length of the user's arm.

After step S103 is processed, the conversion parameter C is updated by the following equation (3) (step S104).
C=(T1−Vtmin)/(L1−Lmin) (3)

Next, the CPU 31 controls the acceleration sensor 52 to detect a motion of the portable device 3 (step S105). Then, the CPU 31 judges whether the detected motion corresponds to a motion for releasing the calibration mode (step S106). The motion for releasing the calibration mode is, for example, a motion where the user throws away a star image on the left display unit 36 with the portable device 3 in the user's hand.

If the detected motion does not correspond to the motion for throwing away the star image (S106: NO), control returns to step S103. If the detected motion corresponds to the motion for throwing away the star image (S106: YES), the process of the calibration mode terminates.

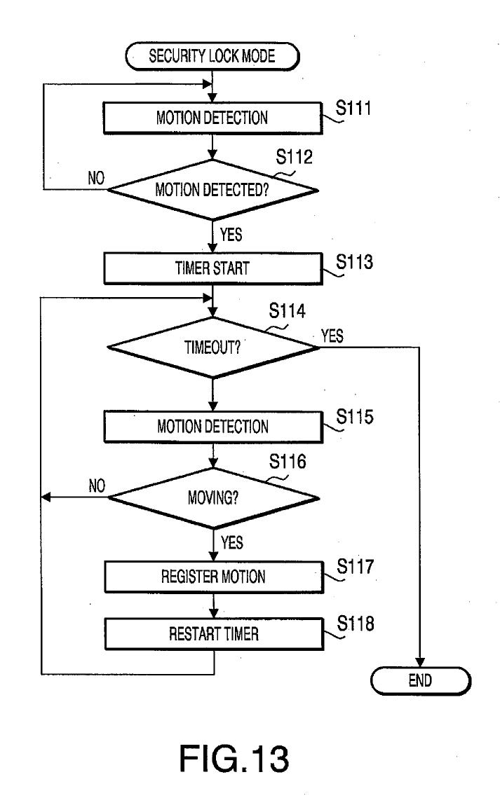

FIG. 13 is a flowchart illustrating a process of the security lock registration mode. First, the CPU 31 controls the acceleration sensor 52 to detect a motion of the portable device 3 (step S11). Then, the CPU 31 judges whether a motion of the portable device 3 is detected (step S112).

If no motion is detected (S112: NO), control returns to step S11 to detect a motion to the portable device 3. If a motion is detected (S112: YES), a timer is started (step S113). Then, control proceeds to step S114.

In step S114, the CPU 31 judges whether a timeout occurs (i.e., whether a predetermined time has elapsed from the start of the timer in step S113). If a timeout occurs (S114: YES), the process of the security lock registration mode terminates. If a timeout does not occur (S114: NO), control proceeds to step S115.

In step S115, the CPU 31 controls the acceleration sensor 115 to detect a motion of the portable device 3 again. Then, the CPU 31 judges whether the portable device 3 is moving (step S116). If the portable device 3 is moving (S116: YES), the CPU 31 stores the motion of the portable device 3 (i.e., the positions and time) in the non-volatile RAM 34 (step S17). Then, the timer is restarted (step S118). Then, control returns to step S114. by repeating steps S114 to S118, a plurality of pairs of positions and arrival times are stored in the non-volatile RAM 34.

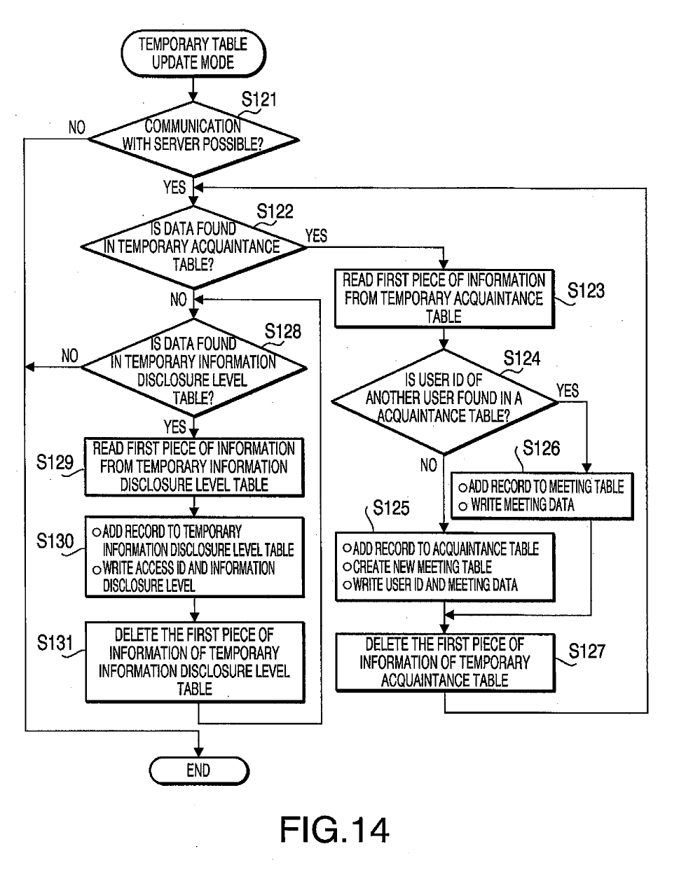

FIG. 14 is a flowchart illustrating a process of the temporary table update mode. First, the CPU 31 judges whether data communication with the server 2 is possible (step S121). If data communication with the server 2 is impossible (S121: NO), the process of the temporary table update mode terminates. If data communication with the server 2 is possible (S121: YES), control proceeds to step S122.

In step S122, the CPU 31 judges whether the temporary acquaintance table contains data. If the temporary acquaintance table contains data (S122: YES), the CPU 31 reads a first piece of information from the temporary acquaintance table (step S123). Then, the CPU 31 judges whether the user ID of another user contained in the information obtained in step S123 has been already registered in the acquaintance table 42 (step S124). If it is judged in step S124 that the acquaintance table 42 does not have the user ID of another user (S124: NO), control proceeds to step S125.

In step S125, the CPU 31 adds a new record to the acquaintance table 42 which is already created in association with the personal table 41 of the principal M1, and creates a new meeting table 43 in association with the record newly added to the acquaintance table 43. then, the CPU 31 records the user ID of another user in the new record of the acquaintance table 42, and adds a new meeting record containing meeting data (a date and time and a place of a meeting) obtained based on information from the RTC 37 and the GPS sensor 38 is added to the new meeting table 43 as a first record.

If it is judged in step S124 that the acquaintance table 42 has the user ID of another user (S124: YES), control proceeds to step S126. In step S126, the CPU 31 adds a new meeting record to the meeting table 43 which has been already created in association with the acquaintance table 42. Then, the CPU 31 records the meeting data to the new meeting record.

After step S125 or S126 is processed, the first piece of information of the temporary acquaintance table is deleted (step S127). Then, control returns to step S122. The steps S122 to S127 are repeated until all of pieces of information in the temporary acquaintance table are processed. After all of the pieces of information in the temporary acquaintance table are processed, control proceeds to step S128.

In step S128, the CPU 31 judges whether the temporary information disclosure table stored in the non-volatile RAM 34 includes data. If the temporary information disclosure table includes data (S128: YES), a first piece of information (i.e., an access ID and an information disclosure level) in the temporary information disclosure table is obtained (step S129). Then, control proceeds to step S130.

In step S130, a new record is added to the information disclosure level table 44 in the server 2. Then, the access ID and the information disclosure level obtained from the temporary information disclosure table are recorded in the newly created record of the information disclosure level table 44.

Next, the CPU 31 deletes the first piece of information in the temporary information disclosure table (step S131). Then, control returns to step S128. The steps S128 to S131 are repeated until all of pieces of information in the temporary information disclosure table are processed. If all of pieces of information in the temporary information disclosure table are processed (S128: NO), the process of the temporary table update mode terminates.

In the above mentioned embodiment, the meeting table 43 includes a plurality of pieces of meeting date and time data as a plurality of records A11, A12, A13, . . . . Therefore, regarding a person (another user M2) who has met the principal M1, the number of times that the principal M1 met the person (another user M2) can be easily obtained by counting the number of records in the meeting table 43. Further, the principal M1 is able to know the date and time when the principal M1 first met the person (another user M2) and how often the principal M1 met the person (another user M1) since the principal M1 first met the person (another user M2).

Since the meeting place is also registered in each record of the meeting table 43, the principal M1 is also able to know the place where the principal met the person (another user M2).

Since the memo can be recorded in each record of the acquaintance table 42 and the meeting table 43, it becomes possible to smoothly carry out a meeting and make meaningful discussions in the meeting. Since the memo is recorded in each record of the meeting table 43, it is possible to record important comments for each meeting. Since the meeting table 43 is configured such that new record is can be added successively to the meeting table 43, a large amount of information regarding another M2 can be recorded.

As described above, the portable devices 3 exchange the user ID with each other in response to the fact that a detected motion and a detected brightness satisfy predetermined conditions. Therefore, the user is able to exchange the user ID with another person by simply producing a certain motion with the portable device 3 in the user's hand under a certain brightness condition. Since the user ID is not exchanged unless the user produces a certain motion under a predetermined brightness condition, it becomes possible to prevent information from being exchanged between the portable devices regardless of the user's intension.

When the user ID of another user is transmitted from the portable device of the principal M1 to the server 2, the server 2 finds out the detailed information regarding another user M2 from the personal table 41, the acquaintance 42, and the meeting table 43 to provide the detailed information for the portable device 3 of the principal M1. Such a configuration enables the principal M1 to smoothly carry out a meeting based on the obtained detailed information.

Since the motion is stored in the non-volatile RAM 34 as secret information, it is possible to easily release a prohibition state whether a certain operation of the portable device 3 is prohibited by simply reproduce the motion stored as secret information, Since the secret information is not a fingerprint and a voice print but is the motion of the portable device 3, it is possible to suppress a possibility of occurrence of a situation where the authentication can not be performed because of accidents such as injury or disease (e.g., a cold). That is, it is possible to securely perform user authentication.

The range of disclosure of the business card information can be selected by performing the shaking motion a predetermined number of times. Therefore, it is possible to change the range of disclosure of the business card information according to circumstances.

As described above, the larger the number of times of handshake increases, the wider the range of disclosure of the business card information becomes. That is, the information disclosure level is determined in accordance with a real motion representing the familiarity with a person. Such a configuration makes it possible to prevent the user from forgetting the motion for broadening or narrowing the range of disclosure of information. In general, the larger the number of times of handshake becomes, the higher the relationship of trust between users becomes. Therefore, it becomes possible to prevent the user from forgetting the user operation.

Information to be displayed can be changed by simply moving the portable device 3 toward the user or away from the user. Such a configuration enables the user to easily brows the time-series information even if the portable device 3 is downsized. Since the time-series information is obtained from the server 2 such that the larger the distance between the portable device 3 and the user becomes, the older the information obtained from the server 2 becomes. Therefore, it becomes possible to match the relationship between the distance and the time with the user's sense (e.g., the sense of “near future” or “distance past”). Such a configuration prevents a user from forgetting a user operation to be performed for changing the information to be displayed.

As described above, the left display unit 36 displays a star image corresponding to each piece of information displayed on the right display unit 35. Therefore, the user is able to brows information referring to the star image. The size of the star image becomes smaller, as the data tot be displayed becomes older. Therefore, the user is able to search for an old user by moving the portable device 3 while focusing on a star image of a distance star. Such a configuration enables the user to brows the information delightfully.

The user is able to brows the detailed information by producing a motion of scooping a star image with the portable device 3 in the user's hand. Such a configuration enables the user to easily brows the detained information by simply producing a motion of scooping a star image even if the portable device 3 is downsized.

As described above, the displayed information on each of the display units 35 and 36 can be locked through the lock mode, and the locked state can be released. Therefore, it is possible to brows all of the time-series information by locking the displayed information in a state where the user fully stretches the user's arm, folding the user's arm to move the portable device 3 to a position ear to the user, and then moving the portable device 3 away from the user again after releasing the locked state of the displayed information. that is, even if the total amount of the time-series information is large with respect to the length of the user's arm, it is possible to brows all of the time-series information.

Although the present invention has been described in considerable detail with reference to certain preferred embodiments thereof, other embodiments are possible.

It is understood that various features provided by the portable device 3 (i.e., the electronic business card exchange device) may be implemented in various types of devices such as a mobile phone and a personal computer.

The acceleration sensor 52 may be a linear sensor, two dimensional sensor or a three dimensional sensor.

In the above mentioned embodiment, the brightness sensor 54 is used as a sensor for sensing an environmental condition. However, various types of sensors such as a radio wave sensor may be used as a sensor for sensing an environmental condition. If a radio wave sensor is used, the judgment step S41 is executed by judging whether the detected intensity of the radio wave is higher than a predetermined value.

### SECOND EMBODIMENT

Hereafter, a business card information management system according to a second embodiment is described. Since a system configuration of the business card information management system 1 according to the first embodiment can also be applied to the second embodiment, explanations of the second embodiment are made with reference to drawings of the first embodiment. In the followings, explanations focus on features of the second embodiment. As described in detail below, in the second embodiment, a criterion for making a judgment on the release of the security lock is changeable. A security lock release program according to the second embodiment and new programs are stored in the ROM 32.

Similarly to the first embodiment, the security lock release program according to the second embodiment is configured such that prohibition of operation of the portable device 3 is released when a calculation result (i.e., detected positions and arrival times) is equal to the secret information stored in the non-volatile RAM 34. Similarly to the first embodiment, when a detected position corresponding to a certain arrival time is within a predetermined distance with respect to a corresponding position stored as secret information, the portable device judges that the calculation result is equal to the security information.

The predetermined distance (i.e., a criterion) used to judge whether the detected position is equal to the position of the secret information can be changed in accordance with a difficulty level defined in a difficulty setting program which is described later. When execute by the CPU 31 of the portable device 3, the difficulty setting program causes the CPU 31 to obtain the calculation result (the position) stored temporarily in the RAM 33, to obtain the corresponding position stored as secret information in the non-volatile RAM 34, and to obtain information representing a difficulty level so that the judgment on whether the calculated position is equal to the position of the secret information. Then, the CPU 31 obtains distance information from the non-volatile RAM 34 to use the distance information for the judgment.

The difficulty setting program is a program for setting a difficulty level defining a difficulty of releasing the security lock. The difficulty setting program enables the user to change the distance information by setting the difficulty level in accordance with a user operation. More specifically, when executed by the CPU 31, the difficulty setting program causes the CPU 31 to judge which of difficulty levels “1” to “3” is selected by a user operation.

Then, the CPU 31 sets the difficulty level for releasing the security lock (hereafter, referred to as a security lock difficulty level) to “High” if the difficulty level “1” is selected by the user. The CPU 31 sets the security lock difficulty level to “Middle” if the difficulty level “2” is selected by the user. The CPU 31 sets the security lock difficulty level to “Low” if the difficulty level “3” is selected by the user.

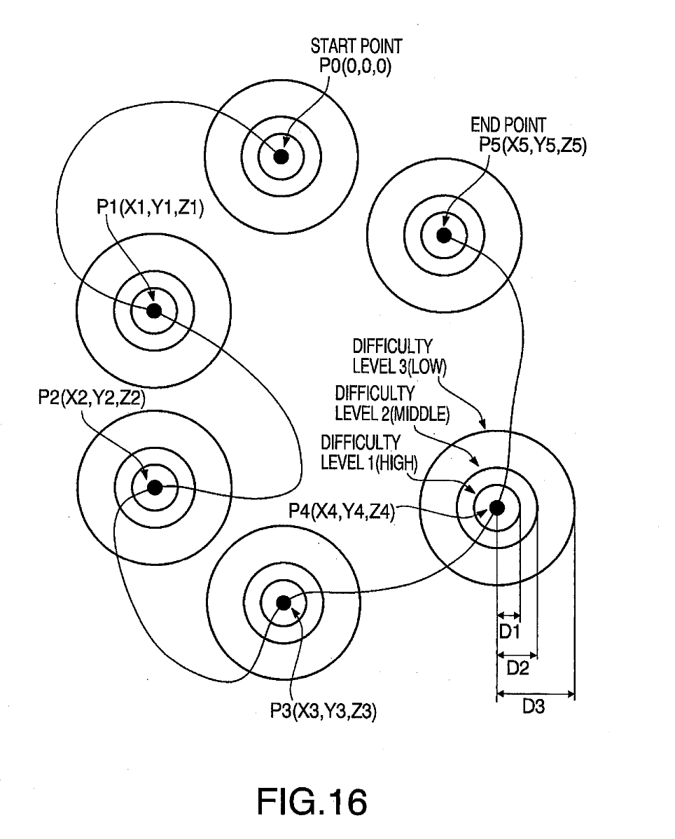

The security lock difficulty level represents a difficulty level of releasing the security lock. That is, the higher the security lock difficulty level becomes, the more difficult the release of the security lock becomes. More specifically, if the security lock difficulty level is “High”, the CPU 31 obtains distance D1 (see FIG. 16) from the non-volatile RAM 34. If the security lock difficulty level is “Middle”, the CPU 31 obtains distance D2 (see FIG. 16) from the non-volatile RAM 34. The distance D2 is larger than the distance D1. If the security lock difficulty level is “Low”, the CPU 31 obtains distance D3 (see FIG. 16) from the non-volatile RAM 34. The distance D3 is larger than the distance D2.

The distance used in the judgment process in the security lock release program as a criterion is thus changed by the user operation.

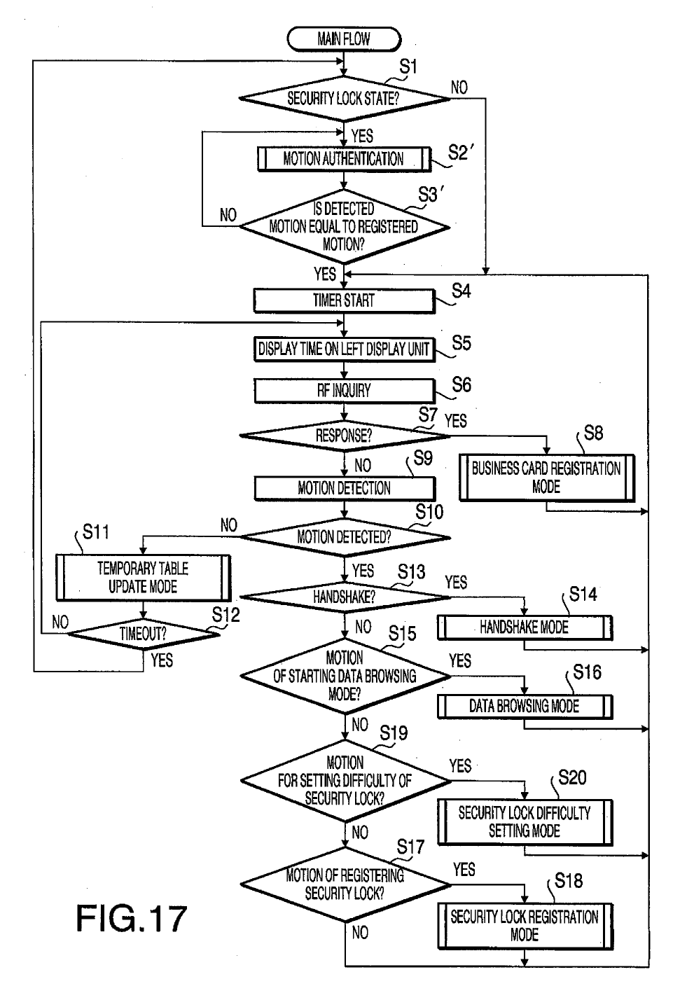

FIG. 17 is a flowchart illustrating a main process according to the second embodiment. In FIG. 17, to steps that are substantially the same as those of the main process according to the first embodiment, the same step numbers are assigned, and explanations thereof will not be repeated. In the main process according to the second embodiment, steps S2′ and S3′ are provided in place of steps S2 and S3 of the first embodiment.

If the CPU 31 judges that the portable device 3 is in the security lock state (S1: YES), the CPU 31 causes the portable device 3 to move to a motion authentication mode (step S2′) After the process of the motion authentication mode is processed, control proceeds to step S3′. In step S3′, the CPU 31 judges whether a result of authentication is success or failure. If the result of authentication is success (S3′: YES), control proceeds to step S4. If the result of authentication is failure (S3′: NO), the CPU 31 judges a detected motion to be unequal to the registered motion. Then, control returns to step S2′.

In the main process according to the second embodiment, a new step S19 is provided. In step S19, the CPU 31 judges whether the detected motion which is detected in step S9 corresponds to a motion for starting a process of a difficulty setting mode for the security lock. Hereafter, this motion is referred to as a difficulty setting motion. The difficulty setting motion is, for example, a motion where the user shakes the portable device 3 in lateral direction with the portable device 3 in the user's hand.

If the CPU 31 judges that the detected motion corresponds to the difficulty setting motion (S19: YES), the CPU 31 causes the portable device 3 to move to the difficulty setting mode (step S20). If the CPU 31 judges that the detected motion does not correspond to the difficulty setting motion (S19: YES), control proceeds to step S17.

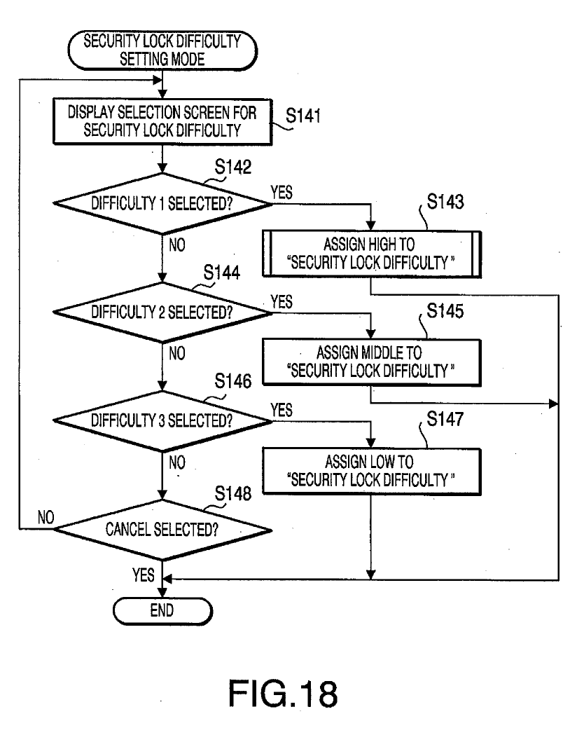

FIG. 18 is a flowchart illustrating the process of the difficulty setting mode for the security lock. First, the CPU 31 displays a screen configured to request the user to make a selection of a difficulty level or to cancel setting for a difficulty level, on the right display unit 35 or left display unit 36. On this screen, four items for selection, such as, “Difficulty Level 1: High Security Level”, “Difficulty Level 2: Middle Security Level” “Difficulty Level 3: Low Security Level” and “Cancel” are displayed. The user is able to select one of the items by producing a predetermined motion or by selecting a button of the portable device 3.

After step S141 is processed, the CPU 31 judges whether the difficulty level “1” is selected (step S142). If the difficulty level “1” is selected (S142: YES), the CPU 31 assigns “High” to the security lock difficulty level (step S143). If the difficulty level “1” is not selected (S142: NO), the CPU 31 judges whether the difficulty level “2” is selected (step S144).

If the difficulty level “2” is selected (S144: YES), the CPU 31 assigns “Middle” to the security lock difficulty level (step S145). If the difficulty level “2” is not selected (S144: NO), the CPU 31 judges whether the difficulty level “3” is selected (step S146).

If the difficulty level “3” is selected (S146: YES), the CPU 31 assigns “Low” to the security lock difficulty level (step S147). If the difficulty level “3” is not selected (S146: NO), the CPU 31 judges whether the item of “cancel” is selected (step S148).

If the item “cancel” is not selected (S148: NO), control returns to step S141 to repeat the steps S141 to S147. If the item “cancel” is selected (S148: YES) or one of the steps S143, S145 or S147 is finished, the process of the difficulty setting mode terminates.

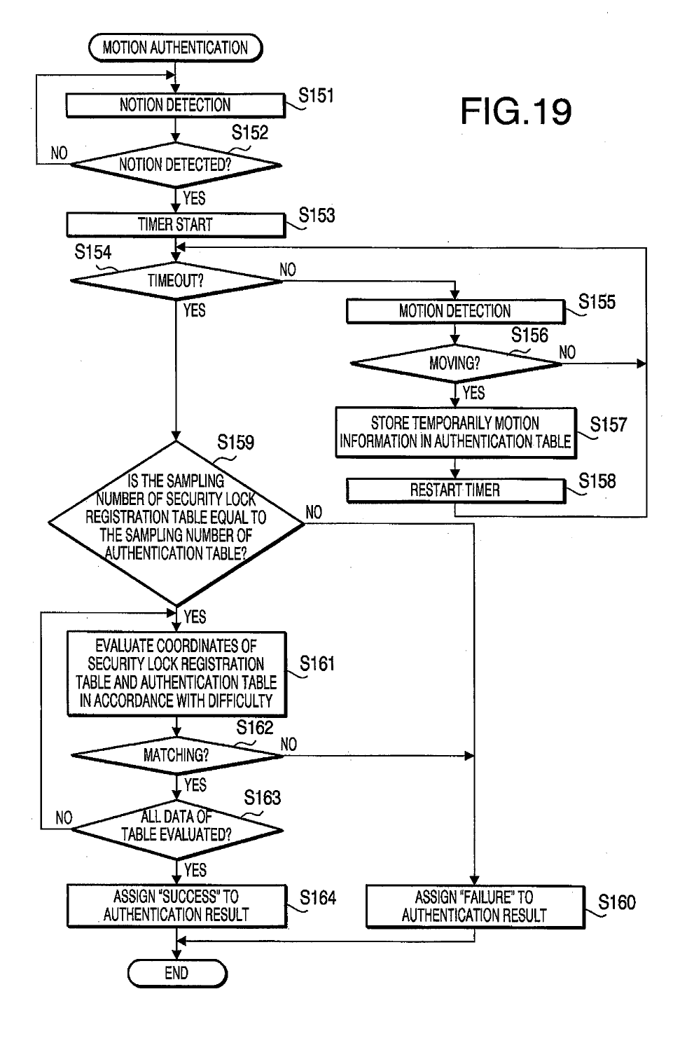

FIG. 19 is a flowchart illustrating the process of the motion authentication. First, the CPU 31 controls the acceleration sensor 52 to detect a motion of the portable device 3 (step S151). Then, the CPU 31 judges whether a motion of the portable device 3i is detected (S152). The CPU 31 waits until a motion of the portable device 3 is detected (S152: NO). If a motion of the potable device 3 is detected (S152: YES), a timer is started (step S153).

Next, in step S154, the CPU 31 judges whether a timeout occurs (i.e., whether a predetermined time has elapsed from the start of the timer). If the CPU 31 judges that a timeout does not occur (S154: NO), the CPU 31 controls the acceleration sensor 52 to detect a motion of the portable device 3 again. Then, the CPU 31 judges whether the portable device 3 is moving (step s156).

If the portable device 3 is moving (S156: YES), the motion (positions and arrival times) detected in step S155 is temporarily stored in an authentication table of the RAM 33 (step S157). Then, a timer is restarted (step S158). If the CPU 31 judges that the portable device 3 is not moving (S156: NO), or step S8158 is finished, control returns to step S154.

If it is judged in step S154 that a timeout occurs (S154: YES), the CPU 31 judges whether a sampling number of the motion information stored in a security lock registration table of the non-volatile RAM 34 as secret information is equal to a sampling number (i.e., the number of sampled points P1, P2, . . . ) of the motion information stored temporarily in the authentication table of the RAM 33 (step S159). If the sample number of the secret information is not equal to the sample number of the detected motion (S159: NO), the CPU 31 generates an authentication result representing failure (step S160). Then, the process of the motion authentication mode terminates.

If the sample number of the secret information is equal to the sample number of the detected motion (S159: YES), the CPU 31 evaluates a difference between each position of the motion information stored in the security lock registration table and a corresponding position of the motion information stored in the authentication table in accordance with the difficulty level defined in the difficulty setting mode (step S161). For example, as shown in FIG. 16, the CPU 31 judges whether a position P11′(X1′, Y1′, Z1′) lies within a certain radius D1, D2 or D3 with respect to a position P1 (X1, Y1, Z1) stored in the security lock registration table. This judgment can be made by judging whether the following relationship (4) is satisfied:
\sqrt{{(X1′−X1)²+(Y1′−Y1)²+(Z1′−Z1)²}}<D (4)

where D represents one of distance D1, D2 and D3 respectively corresponding to the difficulty levels of “1”, “2” and “3”.

In step S161, the CPU 31 judges that the position in the security lock registration table is equal to the position in the authentication table if the relationship (4) is satisfied. In this case, the CPU 31 generates an evaluation result indicating that the coordinates in the security lock registration table are equal to the coordinates in the authentication table. If the relationship (4) is not satisfied, the CPU 31 generates an evaluation result indicating that the coordinates in the security lock registration table are not equal to the coordinates in the authentication table.

Next, in step S162, the CPU 31 judges whether the position in the security lock registration table coincides with the position in the authentication table based on the evaluation result (step S162). If the CPU 31 judges that the position in the security lock registration table does not coincide with the position in the authentication table (S162: NO), control proceeds to step S160 where the CPU 31 generates the authentication result representing failure. Then, the process of the motion authentication mode terminates.

If the CPU 31 judges that the position in the security lock registration table coincides with the position in the authentication table (S162: YES), the CPU 31 judges whether all of the sampled positions have been processed (step S163). If all of the sampled positions have not been processed (S163: NO), control returns to step S161 to evaluate an unprocessed position.

If all of the sampled positions have been processed (S163: YES), the CPU generates the authentication result representing success (step S164). Then, the process of the motion authentication mode terminates.

According to the second embodiment, it is possible to change the distance used, as a criterion, for the judgment regarding the release of the security lock in accordance with the user's intention. If the user wants to increase the security level, the distance used as a criterion can be decreased. If the user wants to decrease the security level, the distance used as a criterion can be increased. It is understood that by increasing the distance used as a criterion, it is possible to enhance ease of release of the security lock.

In the above mentioned embodiment, the acceleration sensor 52 is used as a sensor for sensing a motion. However, various types of sensors including an infrared sensor, a velocity sensor, an angular velocity sensor can be used as a sensor for sensing a motion of the portable device 3.

In the above mentioned embodiment, the CPU 31 prohibits all the operations of the portable device 3 at an initial stage if the portable device 3 is in the locked state (see steps S1, S2 and S3 of the main process). However, the prohibition of operations of the portable device 3 includes various operation modes of portable devices such as a secret mode of a mobile phone, or a prohibition of particular setting items.

### THIRD EMBODIMENT

Hereafter, a business card information management system according to a third embodiment is described. Since a system configuration of the business card information management system 1 according to the first embodiment can also be applied to the third embodiment, explanations of the third embodiment are made with reference to drawings of the first embodiment. In the followings, explanations focus on features of the third embodiment. As described in detail below, in the third embodiment, a part of the handshake mode and a part of the temporary table update mode is changed.

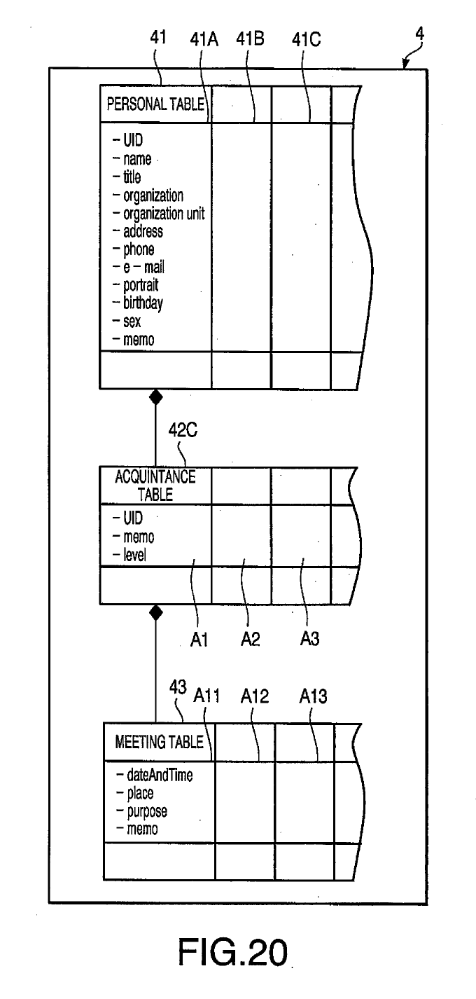

FIG. 20 illustrates a table data structure of tables stored in the server 2 according to the third embodiment. In this embodiment, the information disclosure level is added to each record (A1, A2, A3, . . . ) of an acquaintance table 42c (which corresponds to the acquaintance table 42 of the first embodiment). Such a structure of the acquaintance table 42c eliminates the need for preparing the information disclosure level table 44 of the first embodiment. That is, according to the third embodiment, a table data structure can be simplified.

As described below, the memory 22 of the server 2 stores various programs for achieving features of the third embodiment as well as storing the above mentioned programs according the first embodiment. In this embodiment, the following programs including the disclosure range storing program, and the detailed information transmission program are changed.

In contrast to the first embodiment, the disclosure range storing program according to the second embodiment is configured such that in response to receipt of a user ID of another user and an information disclosure level from the portable device 3 of a certain user, the disclosure range storing program stores the user ID of another user and the information disclosure level in the hard disk drive 4 while associating these pieces of information with the user ID of the certain user.

For example, when executed by the CPU 21 of the server, the disclosure range storing program causes the CPU 21 to receive a user ID of the principal M1, the user ID of another user, and the information disclosure level from the portable device 3 of the principal M1, and to search the personal table 41 for the record 41A corresponding to the user ID of the principal M1 in response to receipt of the above mentioned information from the portable device 3 of the principal M1.

Next, the CPU 21 of the serve 2 searches the acquaintance table 42c associated with the searched record 41A for the record corresponding to the user ID of another user. If the CPU 21 judges that no record corresponding to the user ID of another user is found, the CPU 21 adds a new record to the acquaintance record 42c, and writes the user ID and the information disclosure level in the new record of the acquaintance table 42c. If the CPU 21 judges that the record corresponding to the user ID of another user is fond in the acquaintance table 42c, the CPU 21 updates the information disclosure level of the found record by replacing the information disclosure level already recorded in the table with the newly received information disclosure level.

The detailed information transmission program according to the second embodiment has a different feature regarding the function of restricting the range of disclosure of the business card information based on the information disclosure levels. In response to a request for the business card information of another user from the portable device of a certain user, the detailed information transmission program obtains the business card information of another user and the information disclosure level based on the user ID of the certain user and the user ID of another user which are received from the portable device of the certain user.

Then, the CPU 21 restricts the range of disclosure of the business card information to a certain level in accordance with the obtained information disclosure level, and transmits the restricted business card information to the portable device 3 of the certain user.

For example, when executed by the CPU 21 of the server 2, the detailed information transmission program causes the CPU 21 to perform the following operation. When the CPU 21 of the server 2 receives information (the user 1D of the principal M1 and the user ID of another person M2) representing a request for the business card information of the principal M1 from the portable device 3 of another user M2, the CPU 21 searches the personal table 41 for the record corresponding to another user M2.

If the CPU 21 judges that the record corresponding to the user ID of another user <2 is found in the personal record 41, the CPU 21 searches the acquaintance table 42c associated with the found record of the personal table 41 for a record corresponding to the principal M1. If the record corresponding to the principal M1 is found in the acquaintance table 42c, the CPU 21 obtains the information disclosure level from the searched record of the acquaintance table 42c. Further, if the CPU 21 finds a record corresponding to the user ID of the principal M1 in the personal table 41, the CPU 21 extracts information from the found record of the principal M1 in accordance with the information disclosure level. That is, the CPU 21 restricts the range of disclosure of the business card information to be transmitted. Then, the CPU 21 transmits the restricted business card information to the portable device 3 of another user M2.

As described below, the ROM 32 of the portable device 3 stores various programs for achieving features of the third embodiment as well as storing the above mentioned programs according the first embodiment. In this embodiment, the following programs including the information disclosure range selection program, the disclosure range program, the business card information request program are changed.

Similarly to the first embodiment, the information disclosure range selection program according to the third embodiment has the function of selecting the information disclosure level. However, the information disclosure range selection program according to the third embodiment is configured not to have the function of creating an access ID after selection of the information disclosure level.

The disclosure request program according to the third embodiment is configured such that in response to receipt of a user ID of another user from the portable device 3 of another user, the disclosure request program causes the CPU 31 to transmit the user ID of another user and the information disclosure level.

For example, when executed by the CPU 31, the disclosure request program causes the CPU 31 to execute the following operation. In response to receipt of the user ID of another user M2 from the portable device 3 of another user M2 through the second wireless unit 50, the CPU 31 passes the user ID of another user M2 and the information disclosure level which is selected by the information disclosure range selection program, to the first wireless unit 39.

In contrast to the first embodiment, the business card information request program according to the third embodiment is configured to request transmission of the business card information of another user by transmitting a user's own ID and a user ID of another user to the server 2.

For example, when executed by the CPU 31 of the portable device 3 of another user M2, the business card information request program causes the CPU 31 to execute the following operation. The CPU 31 of the portable device 3 of another user M2 obtains the user ID of the principal M1 received by the second wireless unit 50 (or obtains the user ID of the principal M1 from the non-volatile RAM 34), and obtains the user ID of another user M2 from the ROM 32. Then, the CPU 31 passes the obtained user ID of the principal M1 and the user ID of another user M2 to the first wireless unit 39.

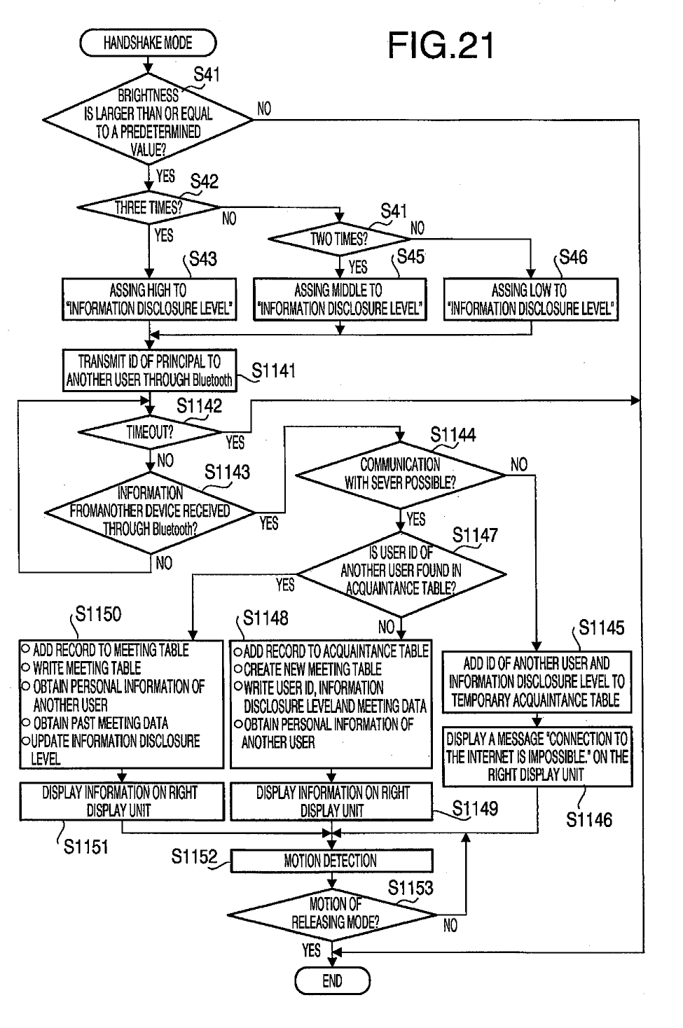

FIG. 21 is a flowchart illustrating a process of a handshake mode according to the third embodiment. In FIG. 21, to steps which are substantially the same as those of the handshake mode shown in FIG. 7, the same step numbers are assigned, and explanations thereof will not be repeated.

After the information disclosure level is determined in step S43, S45 or S46, the user ID of the principal is passed to the second wireless unit 50 to transmit the user ID of the principal to the portable device 3 of another user M2 (step S1141). Then, the CPU 31 judges whether a timeout occurs by judging whether a certain time has elapsed form the start of the time in step S4 of the main process (step S1142). If a timeout occurs (S1142: YES), the process of the handshake terminates.

If a timeout does not occur (S142: NO), the CPU 31 judges whether the user ID of another user M2 is received by the second wireless unit 50 (step S1143). If the user ID of another user M2 is not received (S1143: NO), control returns to step S1142. If the user ID of another user M2 is received (S1143: YES), control proceeds to step S1144.

In step S1144, the CPU 31 judges whether data communication with the server 2 is possible. If the CPU 31 judges that data communication with the server 2 is impossible (S1144: NO), the CPU 31 stores the received user ID of another user and the information disclosure level in the temporary acquaintance table in the non-volatile RAM 34 (step S1145). Then, the CPU 31 displays a message “Connection to the Internet is impossible.” on the right display unit 35 (step S146).

If the CPU 31 judges that data communication with the server 2 is possible (S1144: YES), the CPU 31 judges whether the received user ID of another user has been already stored in the acquaintance table 42c of the server 2 (step S1147). If the user ID of another user is not found in the acquaintance table 42c (S1147: NO), control proceeds to step S1148. More specifically, the judgment in step S147 is carried out by the CPU 21 of the server 2 by using the user ID) of the principal and the user ID of another user transmitted from the portable device 3 to the server 2 in response to the judgment result of “YES” in step S1144. In this case, the CPU 21 of the server judges whether the acquaintance table 42c associated with the record corresponding to the principal in the personal table 41 has a record containing the user ID of another user. Further, the information disclosure level is also transmitted from the portable device 3 to the server 2.

In step S1148, a new acquaintance record is added to the acquaintance table 42 associated with the personal table 41 of the principal M1, and a new meeting table 43 is created in association with the new acquaintance record. Then, the user ID of another user and the information disclosure level are written into the new acquaintance record, and meeting data (a meeting date and time, and a meeting place) created based on information from the RTC 37 and the GPS sensor 38 is recorded in the new meeting table 43 as a first record. Further, the CPU 31 searches the personal record 41 to obtain personal information corresponding to another user M2. In this case, the personal information of another user M2 is restricted to a certain range of disclosure in accordance with the information disclosure level which has been defined by the portable device 3 of another user M2. The information disclosure level is stored in the acquaintance record generated in the acquaintance table 42c in association with the personal information record 41B corresponding to another user M2.

In this case, the CPU 21 of the server 2 searches the personal table 41 for the record 4B storing the user ID of another user M2. if the record 41B is found, the CPU 21 searches the acquaintance table 42c associated with the record 41B for the acquaintance record storing the user Id of the principal. If the acquaintance record storing the user ID of the principal is found, the CPU 21 obtains the information disclosure level stored in the searched acquaintance record. Then, the CPU 21 restricts the disclosure range of the personal information of another user M2 to a certain level corresponding to the obtained information disclosure level, and transmits the restricted personal information to the portable device 3 of the principal M1.

After step S1148 is processed, the personal information transmitted from the server 2 is displayed on the right display unit 35 (step S1149).

If it is judged in step S147 that the acquaintance table 42 has the record corresponding to the user ID of another user, control proceeds to step S1150. In step S1150, a new meeting record is added to the meeting table 43 associated with the acquaintance record 42. Then, the meeting data is written in the new meeting record. Further, the information disclosure level is update by replacing the information disclosure level already written in the acquaintance record corresponding to the user ID of another user M2 with a new one.

Then, the CPU 31 searches the personal table 41 to obtain the personal information of another user M2. In this case, the personal information of another user M2 is restricted to a certain range of disclosure in accordance with the information disclosure level which has been defined by the portable device 3 of another user M2. Further, the CPU 31 also obtains past meeting data generated in the meeting table 43 in association with the acquaintance record corresponding to the user ID of another user.

After step S1150 is processed, the obtained personal information and the past meeting data are displayed on the right display unit 35 (step S1151).

After step S146, S1149, or S11151 is processed, the CPU 31 controls the acceleration sensor 52 to detect a motion of the portable device 3 (step S1152). Next, the CPU 31 judges whether the detected motion corresponds to a motion (hereafter, referred to as a mode release action) for releasing the handshake mode (step S1153). The mode release action is, for example, a motion where the user throws away information displayed on the right display unit 35 with the portable device 3 in the user's hand. Such an action can be produced by flipping vertically the right display unit 35 from top to bottom.

If the detected motion does not correspond to the mode release action (S1153: NO), control returns to step S1152. If the detected motion corresponds to the mode release action (S1153: YES), the process of the handshake mode terminates.

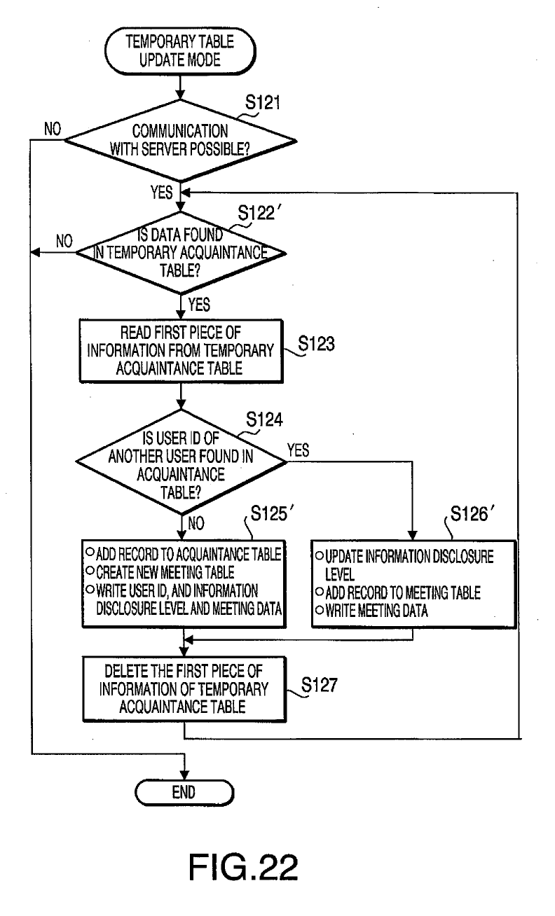

FIG. 22 is a flowchart illustrating a process of the temporary table update mode executed under control of the CPU 31 of the portable device 3. In FIG. 22, to steps which are substantially the same as those of the temporary table update mode shown in FIG. 14, the same step numbers are assigned.

First, the CPU 31 judges whether data communication with the server 2 is possible (S121). If data communication with the server 2 is impossible (S121: NO), the process of the temporary table update process terminates. If data communication with the server 2 is possible (S121: YES), control proceeds to step S122′.

In step S122′, the CPU 31 judges whether the temporary acquaintance table in the non-volatile RAM 34 has data. If the temporary acquaintance table has data (S122′ YES), the CPU 31 reads a first pieces of information from the temporary acquaintance table (step S123). Then, the CPU 31 judges whether the user ID of another person obtained from the temporary acquaintance able is contained in the acquaintance table 42c of the server 2 (step S124). If the user ID of another user is not found in the acquaintance table 42c (S124: NO), control proceeds to step S125′.

In step S125′, a new acquaintance record is added to the acquaintance table 42 generated in association with the personal table 41 of the principal M1, and a new meeting table 43 is created to be associated with the new acquaintance record. Then, the user ID of another user and the information disclosure level are written in the new acquaintance record of the acquaintance table 42c, and meeting data (a date and time and a place) generated based on the information provided by the RTC 37 and the GPS sensor 38 is recorded in the new meeting table 43 as a first record.

If the user ID of another user is found in the acquaintance table 42c (S124: YES), control proceeds to step S126′. In step S126′, a new meeting record is added to the meeting table 43 associated with the acquaintance table 42c. Then, the meeting data is written in the new meeting record. Further, the information disclosure level already stored in the acquaintance record corresponding to the user ID of another user is replaced with a new information disclosure level.

After step S125″ or S126′ is processed, the first pieces of information in the temporary acquaintance table is deleted (step S127). Then, control returns to step S122′. Steps S122′ to S127 are repeated so that all of pieces of information in the temporary acquaintance table have been processed. After all of pieces of information in the temporary acquaintance table have been processed (S122′: NO), the process of the temporary table update mode terminates.

As described, according to the third embodiment, there is no need to prepare the information disclosure table 44. Therefore, the data structure of tables can be simplified.

In the above mentioned third embodiment, the business card information of users is stored in the hard disk drive 4 of the server 2. However, the business card information may be stored in a storage device of the portable device 3 of the user. In this case, the portable device 3 of each user is configured to have the above mentioned programs (e.g., the disclosure range storing program) provided in the server 2.

However, in the above mentioned case, it is required that after an access ID or a user ID is transmitted from a portable device of a certain user to a portable device of the other user, the data including the access ID needs to be transmitted from the portable device of the other user to the portable device of the certain user again so that the other user can brows the business card information of the certain user. For this reason, when the business card information is exchanged between the portable devices, part of the business card information restricted in accordance with the information disclosure level may be directly transmitted to the portable device of the other user in place of transmitting the access ID or the user ID from the portable device of the certain user to the portable device of theater user.

In the above mentioned embodiment, a handshaking motion is used to as a motion for changing information disclosure levels. However, various types of motions produced by a user may be employed as a motion for changing information disclosure levels.

In the above mentioned embodiment, the information disclosure level is defined based on the motion detected by the acceleration sensor 52. However, various types of user operations may be used to change the information disclosure level. For example, the portable device may be configured to have more than one key so as to enable the user to change the information disclosure level through the key. The step S42 of the handshake mode may be a process for judging whether a first key is pressed, and step S44 may be a process for judging whether a second key is pressed. It is understood that such a configuration can easily be achieved if the portable device is a mobile phone without increasing the number of components. The reason is that the mobile phone has operation keys.

In the above mentioned embodiment, the information disclosure levels are classified into three levels of “High”, “Middle” and “Low” so that the personal information of each user can be protected. However, various types of definitions of information disclosure levels can be employed. Considering a case where a user who is a director of company A also serves a director of company B and the user uses the business card information management system, business card information may be recorded in a single personal information record in the personal table 41 for each of the companies that the user belongs. In this case, business card information of each of the companies that the user belongs may be provided for a person, who transmitted a request, in accordance with the type of the request from the person.

It is understood that in this case the need for preparing a plurality of records corresponding to the number of companies in the personal table 41 can be eliminated. Therefore, the data structure of tables can be simplified, and efficiency of using tables can be enhanced. In this case, a plurality of information disclosure levels may be prepared depending on the number of companies (companies A, B, . . . ) that the user belongs.

What is claimed is:

1. A business card information management system, comprising:
a server; and
a plurality of portable devices communicatably connected to the server,
wherein the server comprises a storage unit storing:
a personal table in which a record containing a user ID and business card information of a user corresponding to the user ID is stored for each of a plurality of users of the plurality of portable devices;
an acquaintance table which is associated with one of records of the personal table corresponding to a certain user of the plurality of users, the acquaintance table having at least one record containing a user ID of one of the plurality of users other than the certain user; and
a meeting table which is associated with one of the at least one record of the acquaintance table corresponding to one of the plurality of users other than the certain user, the meeting table having at least one record containing meeting data representing a date and time of a meeting,
wherein the server further comprises an addition unit configured such that in response to receipt of the meeting data representing a date and time of a meeting from one of the plurality of portable devices, the addition unit adds a new record to the meeting table and to store the meeting data in the new record,
wherein each of the plurality portable devices comprises:
a data exchange unit configured to exchange user IDs with another one of the plurality of the portable devices;
a date and time obtaining unit configured to obtain a date and time as the meeting data in response to exchange of user IDs by the data exchange unit; and
a transmission unit configured to transmit the meeting data, a portable device's own user ID and another user's ID obtained from another one of the plurality of the portable devices by the data exchange unit, to the server, in response to exchange of user IDs by the data exchange unit.

2. The business card information management system according to claim 1, wherein:
the acquaintance tables has a plurality of records each of which contains a user ID of one of the plurality of users other than the certain user; and
the meeting table is associated with one of the plurality of records of the acquaintance table, and has a plurality of records each of which contains the meeting data.

3. The business card information management system according to claim 1,
wherein each of the plurality portable devices further comprises a position detection unit configured to detect a portable device's position and to provides the detected position for the transmission unit as meeting place data,
wherein:
the transmission unit transmits additionally the meeting place data to the server in response to exchange of user IDs by the data exchange unit; and
the addition unit of the server stores additionally the meeting place data received from the portable device in the new record of the meeting table when the meeting data is stored in the new record of the meeting table.

4. The business card information management system according to claim 3,
at least one of the record of the acquaintance table and the record of the meeting table has an area in which a memo inputted through a user operation is stored.

5. The business card information management system according to claim 1,
wherein each of the plurality portable devices comprises:
a motion sensor that detects a portable device's motion;
a storing unit;
a registration unit configured to register the portable device's motion detected by the motion sensor in the storing unit as secret information;
a prohibition unit configured to prohibit operations of the portable device;
a release unit configured to release prohibition of the operations of the portable device in response to matching between the secret information registered by the registration unit and a motion of the portable device newly detected by the motion sensor.

6. The business card information management system according to claim 1,
wherein each of the portable devices further comprises:
a motion sensor that detects a portable device's motion; and
an environment sensor that detects an environmental condition of the portable device as environmental information,
wherein the data exchange unit exchanges user IDs with another one of the plurality of the portable devices in response to the motion detected by the motion sensor and the environmental information being satisfying respective predetermined conditions.

7. The business card information management system according to claim 1,
wherein the data exchange unit of each of the portable device comprises:
an ID transmission unit configured to generate a unique access ID and to transmit the access ID and the user ID of the portable device to a target device of data exchange by the data exchange unit; and
an ID receipt unit configured to receive an access ID and a user ID of the target device of data exchange from the target device of data exchange,
wherein the portable device further comprises:
a selection unit configured to accept a user operation for selecting a range of disclosure of business card information regarding a user of the portable device;
a disclosure request unit configured to transmit information representing the access ID generated by the ID transmission unit and the range of disclosure selected through the selection unit, to the server;
a business card information request unit configured to transmit a request for business card information of the target device of data exchange to the server by transmitting the access ID and the user ID of the target device of data exchange to the server; and
a business card information receiving unit configured to receive the business card information which is transmitted from the server as a response to the request by the business card information request unit,
wherein the server comprises:
a disclosure range storing control unit configured such that in response to receipt of the access ID and the range of disclosure from a certain portable device, the disclosure range storing control unit stores the received access ID and the range of disclosure in the storage unit while associating the received access ID with the received range of disclosure; and
a business card information transmission unit configured such that in response to receipt of a request for business card information of a user of the certain portable device from a portable device of another user as a transmission target, the business card information transmission unit obtains, from the storage unit, the range of disclosure associated with the access ID transmitted from the transmission target, obtains, from the personal table, the business card information of the user corresponding to the certain portable device based on the user ID corresponding to the certain portable device within the obtained range of disclosure, and transmits the obtained business card information to the transmission target.

8. The business card information management system according to claim 1,
wherein the server further comprises:
a acquaintance checking unit configured such that in response to receipt of a user ID of a check target user who is one of the plurality of users other than the certain user from the portable device of the certain user, the acquaintance checking unit searches the acquaintance table for a user ID corresponding to the check target user;
an acquaintance information search unit configured such that in response to existence of the user ID of the check target user in the acquaintance table checked by the acquaintance checking table, the acquaintance information search unit searches the personal table for a record corresponding to the check target user; and
a detailed information transmission unit configured such that in response to the record corresponding to the check target user being searched by the acquaintance information search unit in the personal table, the detailed information transmission unit transmits information in the record of the personal table searched by the acquaintance information search unit and information in a record of the meeting table associated with the record of which existence in the acquaintance table is checked by the acquaintance checking unit, to the portable device of the certain user,
wherein each of the plurality of portable devices comprises:
a display unit configured to display the information transmitted from the server.

9. The business card information management system according to claim 1,
wherein the business card information of the user includes at least a name of the user corresponding to the user ID.

10. The business card information management system according to claim 1, wherein the data exchange unit exchanges the user IDs by a data communication.

11. The business card information management system according to claim 10, wherein the data communication comprises a wireless communication.

12. The business card information management system according to claim 1, wherein the addition unit stores the meeting data in the new record based on a portable device's own user ID and another user's ID which are transmitted by the transmission unit together with the meeting data.

13. The business card information management system according to claim 12,
wherein, if the acquaintance table does not include a record related to a record of the personal table corresponding to a portable device's own user ID and containing another US's ID, the addition unit adds a new record, which is related to the record of the portable device's own user ID and containing the another user's ID, to the acquaintance table, and creates a meeting table related to the new record containing the another user's ID, the addition unit adding a record to the created meeting table and adding the meeting data to the added record of the meeting table.
